(19) United States
(12) Patent Application Publication
(10) Pub. No.: US 2021/0050125 A1
(43) Pub. Date: Feb. 18, 2021

(54) ROTATING BED APPARATUS AND METHODS FOR USING SAME

(71) Applicant: ATKINS ENERGY PRODUCTS & TECHNOLOGY, LLC, Tampa, FL (US)

(72) Inventors: Paul SYLVESTER, Waltham, MA (US); Timothy MILNER, Lexington, SC (US); Scott HENDRICKS, Lexington, SC (US); Corin BROTHERHOOD, Sheffield (GB); Jack GROOM, Sheffield (GB)

(21) Appl. No.: 17/052,095

(22) PCT Filed: May 1, 2019
(86) PCT No.: PCT/US2019/030238

§ 371 Date: Oct. 30, 2020

Related U.S. Application Data
(60) Provisional application No. 62/665,477, filed on May 1, 2018.

(51) Int. Cl. G21F 9/12; C02F 1/42

(52) U.S. Cl. CPC G21F 9/12; C02F 2101/006; C02F 1/42

(57) ABSTRACT

A method for removing radioactive material from waste water comprises rotating a bed of ion exchange media in the waste water.

### CROSS-REFERENCE TO RELATED APPLICATIONS

This application claims all benefit including priority to U.S. Provisional Patent Application 62/665,477, filed May 1, 2018, and entitled “Rotating Bed Apparatus and Method for Using Same”, the entirety of which is hereby incorporated by reference.

### FIELD

The present disclosure relates to the field of industrial filtration and/or technologies for removing components from a fluid. In particular, aspects of embodiments of the present disclosure relate to the field of apparatuses, systems and methods for removing components from a fluid involving a rotating bed apparatus.

BACKGROUND

Conventional ion exchange and adsorption processes are relatively mature technologies for the removal of undesirable components from a liquid stream such as drinking water, nuclear wastes and industrial wastewaters. The conventional approach to treat a waste source is to construct a treatment plant and pump the waste through a series ion exchange or adsorption columns to remove the desired contaminants. The effluent is then stored, sampled, and analyzed prior to being discharge to the environment.

In the application of traditional fixed column ion exchange processes filtration is usually necessary up front of the ion exchange columns since the media can be prone to fouling by suspended solids. This conventional approach is expensive, time consuming and can require a significant plant footprint.

### SUMMARY

In some embodiments, a rotating bed apparatus (RBA) can be used in nuclear or large scale applications to remove radioactive or other material from waste water (or remove any contaminant from any liquid waste stream). For example, in some applications, the removed radioactive material can include radionuclides such as 1-129, Sr-85, Cs-137 and the like. In some instances, an RBA approach can be simpler and more flexible than a conventional fixed bed ion exchange system and may require less auxiliary equipment (pump, piping, filter, etc.) than would normally be required to perform similar ion exchange operations. In some situations, an RBA can be used to apply ion exchange technology at a fraction of the cost of current fixed large ion exchange facilities.

In accordance with one aspect, there is provided an apparatus for processing industrial effluent. The apparatus includes: an annular body having an inner surface and an outer surface defining one or more chambers for retaining exchange media, the inner and outer surfaces defining a plurality of apertures, the inner surface defining a central volume in fluid communication with a central aperture at a first end of the annular body. When rotated in a volume of fluid, the annular body facilitates fluid flow into the central volume via the central aperture, into the one or more chambers via the apertures defined by the inner surface, and out the apertures defined by the outer surface.

In accordance with another aspect, there is provided a system including: an apparatus as described above or herein, and a mast mountable on a support such that the annular body can be extended into the volume of fluid through the mast.

In accordance with another aspect, there is provided A method for processing industrial effluent. The method includes positioning, in a volume of fluid, a rotating bed apparatus comprising one or more chambers retaining exchange media; and rotating the rotating bed apparatus to facilitate fluid flow through the one or more chambers of the rotating bed apparatus.

One or more representative embodiments are provided to illustrate the various features, characteristics, and advantages of the disclosed subject matter. The embodiments are provided primarily in the context of treating radioactive waste water in a storage tank. It should be understood, however, that many of the concepts can be used in a variety of other settings, situations, and configurations such as treating radioactive waste water in an open pool or treating waste water that does not contain radioactive contaminants. Also, the features, characteristics, advantages, etc., of one embodiment can be used alone or in various combinations and sub-combinations with one another.

The summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### BRIEF DESCRIPTION OF THE DRAWINGS

The preferred and other example embodiments are disclosed in association with the accompanying drawings in which:

FIG. 1 is perspective view of one embodiment of a rotating bed system that can be deployed in a waste water storage tank.

FIG. 2 is a perspective view of one embodiment of a flatbed truck that can be used to house and/or transport the modular mechanical equipment.

FIG. 3 is a perspective view of one embodiment of an access platform positioned on top of the tank (left side) and showing one embodiment of the rotating bed apparatus extending into the tank (right side).

FIG. 4 is a perspective view of one embodiment of a drive module unit for the rotating bed apparatus positioned inside one embodiment of a support mast and;

FIG. 4A is a perspective view of the RBA standing alone.

FIG. 5 is a process flow diagram illustrating one embodiment of a sequence that can be used to deploy a rotating bed system

FIG. 6 is a perspective view of one embodiment of a mobile rotating bed apparatus unit that can be deployed to treat waste water in a tank.

FIG. 7 is a top view of the mobile rotating bed apparatus unit in FIG. 5.

FIGS. 8-9 are perspective views of one embodiment of a mobile rotating bed apparatus that can be telescopically inserted through an opening in the tank.

FIG. 10 is a photograph from a top perspective view of the RBR containing granular media after use.

FIG. 11 is a photograph of three beakers containing Cs-Treat media before (left beaker) and after spinning in the RBR at speeds of 500 rpm (middle beaker) and 250 rpm (right beaker).

FIG. 12 is a photograph of two beakers containing Cs-Treat media washed in the RBR (left beaker) and the as-received Cs-Treat media (right beaker).

FIGS. 13-14 are photographs of a dye/clay mixture before (FIG. 13) and after the RBR was used to remove the dye.

FIG. 15 is a photograph of the RBR partially filled with Cs-Treat media after being used to remove Cesium from a simulated nuclear tank waste solution.

FIG. 16 is a photograph of the RBR with the top plate removed and after being used to remove I-125 using small uniform particles.

FIG. 17 is a photograph of a double RBR device used to remove I-125 from a simulated nuclear tank waste solution.

FIG. 18 exploded view showing aspects of an example apparatus and/or system for processing industrial effluent.

FIG. 19 is a cross-sectional view showing aspects of an example apparatus and/or system for processing industrial effluent.

FIG. 20 is a top plane view showing aspects of an example apparatus and/or system for processing industrial effluent.

FIG. 21 is a radial cross-sectional view showing aspects of an example annular body.

FIG. 22 is a cross-sectional view showing aspects of the example annular body of FIG. 21 taken at A-A.

FIG. 23 shows aspects of an example supporting structure positioned over a vessel containing a volume of fluid.

FIG. 24 shows an example system/method for a restricted access environment.

FIG. 25 shows another example system/method for a restricted access environment.

FIG. 26 shows mixing times for an RBR device positioned at different locations in a vessel.

FIG. 27 shows different exchange media having different aspect ratios.

### DETAILED DESCRIPTION

In some embodiments, an example RBA can be used with media used in the nuclear sector for ion exchange without degrading. In some situations, the RBA can remove at least 80%, at least 90%, or at least 95% of the contaminants within a few hours. In some embodiments, the RBA can be used to simultaneously remove multiple contaminants by packing chambers in the RBA with different ion exchange media.

In some embodiments, the RBA may provide an efficient mixing device. In some situations, a single 400 mm diameter, 800 mm high RBA can effectively agitate and stir the contents of a waste tank containing 2900 m³ of liquid. The RBA can be deployed using a engineered scheme having a remote latching and de-latching RBA. The cost associated with treating nuclear waste water with the RBA is lower than the cost to use conventional fixed bed ion exchange systems.

In some embodiments and in some situations, the RBA technology may provide a number of benefits compared to conventional water processing systems. One potential benefit is that the RBA system uses less equipment than a conventional water treatment system, which requires a piping, valves, pumps, pressure vessels, control systems, sensors, pressure gauges and numerous connections with the potential for leakage. Conventional water treatment systems are relatively complex to operate and experience difficulties with the chemistry. In some embodiments and/or situations, aspects of the present application may reduce costs and/or minimize potential hazards associated with the pumping of the wastes from a storage tank or pool to a treatment equipment. It may also reduce the time needed to treat a given volume of waste water and may decrease the amount of solid waste generated by better utilizing available media capacity.

In some embodiments, the RBA can be configured to process any suitable amount of liquid. In one embodiment, it can process 44 m³/hr or 200 gpm (0.76 m³/minute). This is roughly 6 times faster than a standard nuclear waste water system, which processes 30 to 35 gpm (0.11 to 0.13 m³/minute).

Conventional treatment systems such as ion exchange and/or reverse osmosis require two trains, very large capacity vessels, several membrane arrays with dual pass to provide the same flow as the RBA. This type of system is not portable and would require a central location for all tank farms. Tank water would have to be pumped via piping and hoses across the site. The relative cost is high.

Conventional ion exchange systems and especially reverse osmosis systems, require pre, and post filtration to prevent fouling of the ion exchange beds and sensitive membranes. These filters add considerable additional waste, associated cost for filters, disposal and added personnel dose from filter change-outs.

Conventional ion exchange and reverse osmosis systems require a large footprint such as 60 to 120 square meters for a dual train system capable of 44 m³/hour. All this equipment must be protected from the weather and heated to prevent freezing with a building or some sort of enclosure. This adds significantly to the overall cost.

In some embodiments, the RBA system can include a smaller amount of less complex equipment, can be portable, and in most situations will not require a building or heating system. If the water in the tank is accessible to place the RBA in, it can be processed with minimal support services.

In some embodiments, the RBA can include ion exchange media placed in a porous container connected to a shaft. The RBA can be lowered into the waste liquid and spun using an external drive motor. In operation, water or another fluid is sucked into the center of the RBA and expelled through the media. In nuclear applications, radioactive contaminants can be removed with the RBA in place of (or in addition to) a conventional ion exchange system.

In some situations, embodiments of some RBA systems, device and/or methods may provide one or more advantages: (1) no treatment plant (temporary or permanent) is required, (2) the approach is resistant to fouling by suspended solids so filtration is unlikely to be required., (3) no receiving vessel for the treated effluent is needed, (4) deployment time may be drastically reduced, (5) the spent cartridge may be dewatered for burial site acceptance simply by rotating above the water in the tank after use, (6) the footprint is minimal compared to a standard plant, (7) the cost is significantly reduced, (8) waste management costs are reduced through simplification by disposal of a single contaminated, dewatered radioactive cartridge, or (9) ALARA (as low as reasonably achievable) is greatly enhanced by removing multiple process steps that would otherwise cause operators to receive a radiation dose. In addition, in some situations and/or embodiments, all operations can be simple remote operations that can be conducted in the tank/container housing the radioactive effluent, thereby greatly minimizing operator contact with the radioactive source material.

There are multiple applications of the RBA within the nuclear industry where significant cost and/or time savings may be achieved compared to using a conventional fixed bed system. One example is the treatment of radioactive wastes stored at the Fukushima site in Japan. These wastes contain significant amounts of 1-129, a radioactive isotope of particular environmental concern due to its propensity towards bioaccumulation. Treatment of these wastes using a conventional approach would require the construction of a large fixed bed ion exchange plant necessitating the risk of piping large volumes of waste from storage tanks to the treatment facility. This results in an increased environmental risk from environmental leakage/spillage. Aspects of the present application may provide an alternate approach which treats the wastes directly in the tanks using the RBA, thus minimizing liquid transfer and mitigating environmental risks.

Additional applications where the RBA may be employed include but are not limited to: (1) deployed from floating (static or mobile) platforms in fuel pools storing radioactive spent fuel and other solid wastes, (2) replacing existing fixed ion exchange systems at commercial nuclear plants. This can include a placement on top of a High Integrity Container (HIC) or other tank or vessel to process effluents and remotely discharge spent and reload new ion exchange resin in a continuous flow process, (3) extraction of specific radionuclides of concern in High Level Waste (HLW) tanks including but not limited to Cs-137, Tc-99, Sr-90, 1-129; In some embodiments, the RBA can be sized and loaded to avoid the generation of excessive hydrogen from radiolysis and excessive heat from isotope decay. These being two very limiting factors experienced when using fixed ion exchange columns for HLW processing; (4) extraction of non-radioactive species that reduce glass integrity or minimize waste loading during vitrification processes (e.g., chromate), and the like. (5) In addition to filling the RBA with ion exchange media for a one use application and also remotely filling and emptying media into and out of the RBA for continuous and multiple application, in some embodiments, the RBA can be configured to use disposable preloaded cartridges of ion exchange media in the reusable RBA. In some situations, this offers the possibility of segregation of spent ion exchange media in cartridges for efficient waste disposal of individual ion exchange media and associated radionuclides.

In some embodiments, the RBA design includes: (1) shielding—to reduce operator dose from radioisotopes adsorbed on to the media during RBA replacement or replacement, (2) automation—designed to minimize operator contact with the RBA reducing hazardous associated with radioactivity, (3) RBA design—the design can been modified for a variety of applications and circumstances, (4) media options—by selecting the size of the screen in the RBA used to retain the media, smaller particle sizes of media can be used compared to a fixed bed IX system resulting in improved media reaction kinetics, faster waste processing times and reduced project costs. (5) In some instances, it may be required to remove solid particulate radioactive waste using the RBA and this may be achieved by the introduction of a powdered filter media such as POWDEX into the RBA or the addition of multiple staged and graduated filter screens with sequentially decreasing pore size to provide a non-fouling graded filtration across the RBA circumference.

In some embodiments, the rotating bed apparatus may be used to minimize slow reaction kinetics caused by poor mass transfer between the solution and solid phase. The rotating bed design is flexible and can, in some situations, be used for heterogeneous reactions with numerous types of solid phases, including catalysts, adsorbents and ion exchangers. Utilizing the rotating bed apparatus may, in some scenarios, result in faster processes, higher yields or reduced consumption of reagents, depending on the type of process. In addition, the rotating bed apparatus may, in some situations, extend the lifetime of the solid phase particles by minimizing grinding and fines, while at the same time simplifying the solid phase collection and recycling.

In some embodiments, the rotating bed apparatus can be configured to hold multiple types of ion exchange media that target different isotopes or ions. In one embodiment, different ion exchange media can be used at the same time in the rotating bed apparatus—e.g., the different ion exchange media can be placed in separate compartments in the rotating bed apparatus. This may make the rotating bed apparatus flexible compared to a fixed bed ion exchange system. In another embodiment, a single ion exchange media can be used in the rotating bed apparatus.

In some embodiments, the rotating bed apparatus for industrial scale for large applications can have a significant size and/or weight. Accordingly, in some embodiments, structural and/support considerations can be important technical challenges in contrast to smaller scale or laboratory sized applications. In nuclear-related or other applications, minimizing human exposure to some affluent material can also provide additional technical challenges.

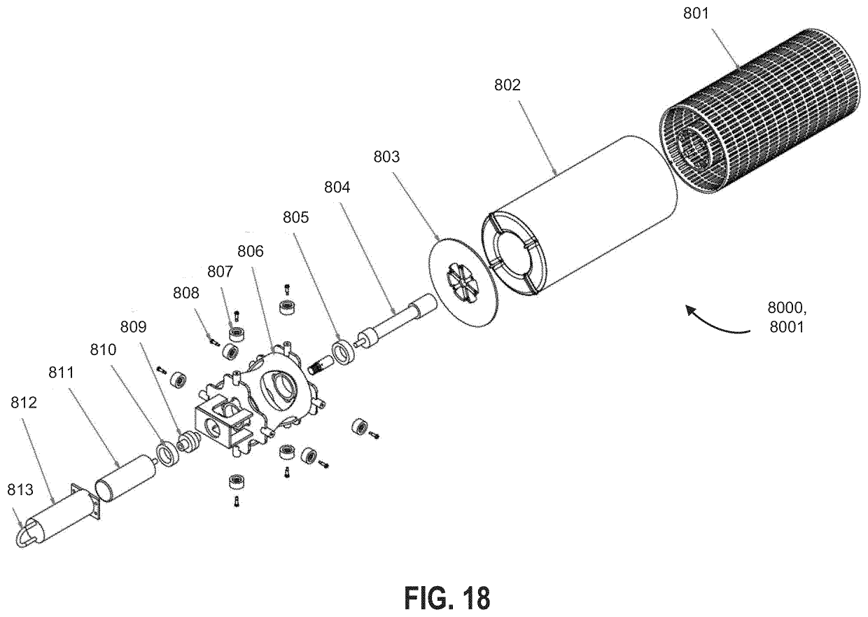

FIG. 18 shows aspects of an example apparatus 8000 and/or system 8001. In some embodiments, the apparatus and/or system are configured on the basis that the rotation induces a radial flow of liquid across the exchange media (e.g. ion exchange material) bed of the RBA. In some embodiments, the media is contained by the annulus created by the outer and inner casings and the upper and lower plates. In some embodiments, upper and lower plates close off the top and bottom of the annulus preventing axial flow, however the inner and outer casings are both perforated to allow radial fluid flow. The size of the perforations as shown in the figures are illustrative only and are not necessarily to scale. In some embodiments, the inner and outer casings provide structural support for one or more (e.g. inner and outer) meshes that provide for the containment of the granular exchange media.

In some embodiments, within the annulus, there can be a number of dividers or baffles. In some embodiments, these can be radially orientated (4 shown but any even number is acceptable). In some embodiments, the internal structures of the annulus can provide for multiple chambers for retaining exchange media.

In order to perform the (ion) exchange process, the RBR is rotated. The rotation of the RBR makes the RBR work in the same or similar manner as a radial pump. The baffles and media rotate thereby pushing the water outwards through the media interstices by centripetal acceleration. The outward radial movement of the liquid through the RBR produces a fluid flow from the open inner core radially outwards through the media and out through the outer casing into the bulk tank again. Continuing to rotate can, in some embodiments, maintain this fluid flow thereby inducing a pumping action through the RBR. The flow of fluid over the media enables/facilitates the (ion) exchange process.

In some embodiments, the rotational speed of the RBR is controlled dependent on requirements of each individual application (e.g. based on fluid types/compositions, exchange media, fluid volume/dimensions, etc.). IN some embodiments, the rotational speed of the RBR has been shown to be effective between 200 and 500 rpm.

In some embodiments, the apparatus includes an annular body 901 having an inner surface and then outer surface define the one or more chambers for interior volumes for retaining exchange media. In some embodiments, the inner and outer surfaces to find a plurality of apertures. A perforated outer casing of the annular body provides structural support to the mesh containing the exchange media 802. The mesh pore size is dependent on the type of exchange media. In some embodiments, the mesh pore size is around 100micron. The size of the mesh pores and the size of the larger holes in the outer casing may be optimised for different applications. In some embodiments, the combination of structural casing and mesh is designed to prevent the media from escaping the annulus under the loads produced when the RBR is rotated at its operating speeds.

A perforated inner casing of the annular body provides structural support to the mesh preventing the media from escaping the annulus on the inside diameter. In some embodiments, the structural requirement is less for the inner mesh as the rotational loads will not be imparted on the inner mesh due to centripetal acceleration.

In some embodiments, the annular body includes a lower plate defining a including central aperture. In some embodiments, the lower plate of the RBR prevents the media from escaping the containment annulus. In some embodiments, the centre of the plate is open providing an aperture of a similar diameter to the inner RBR core diameter thereby allowing free flow of fluid from the bulk liquid volume up through the aperture and into the open core (central volume) of the RBR.

In some embodiments, the apparatus includes baffles. In some embodiments, the baffles constrain the rotation of the media to that of the RBR. In some embodiments, they can also be used to allow the filling of the RBR using different types of media. In some embodiments, the RBR is balanced by filling diametrically opposite annulus sections with the same media.

In some embodiments, the exchange media 802 is of a granular form. The media can be poured into the sections of the aperture created in the RBR until the annulus is full of media or is filled based on flow, fluid and media considerations.

In some embodiments, the annular body includes an upper plate 803. In some embodiments, the upper RBR plate optionally includes a central aperture allowing fluid flow from the bulk liquid container into the central core of the RBR. Connection details on the upper plate allow the RBR to be fixed to the drive shaft 804 providing a mechanism for translating the rotation of the motor into rotation of the RBR.

In some embodiments, the system and/or apparatus includes an anti-rotation structure such as anti-rotation frame 806.

In some embodiments, the system and/or apparatus includes lower shaft bearing(s) 805 and/or upper shaft bearing(s) 810 to provides support to the drive shaft allowing rotation of the shaft within the anti rotation frame 806.

The anti rotation frame 806 can, in some embodiments, include a structural bodies and/or frame used to support the motor and drive shaft. In some embodiments, the anti rotation frame provides support for the two shaft bearings which support the drive shaft linking the motor and the RBR. In addition to providing the support for the drive shaft, the anti rotation frame can, in some embodiments, be used to prevent the entire RBR and motor assembly from rotating when driven. In some situations, the resistance of all the rotating parts and the RBR within the waste liquid will impart a torque back onto the motor which must be reacted to prevent the entire assembly from rotating. The frame therefore can, in some embodiments, provide support for a number (4 shown in each of 2 layers) of anti rotation roller bearings 807 which are designed to react against a fixed deployment frame (such as a mast) allowing the deployment and retraction of the RBR and motor assembly whilst preventing unwanted rotation of the assembly.

In some embodiments, the system and/or apparatus includes anti rotation bearings 807 which can include a set of bearings used to provide torque reaction of the RBR back into a fixed deployment structure.

In some embodiments, the system and/or apparatus includes shoulder screws 808 or other attachment mechanism(s) to fix the anti rotation roller bearings to the anti rotation frame.

In some embodiments, the system and/or apparatus includes a drive shaft coupling 809 to connect the drive shaft to the output shaft of the motor.

In some embodiments, the system and/or apparatus includes a drive motor 811. In some embodiments, the drive motor is or includes an electrical drive motor to provide the rotational power to rotate the RBR within the waste liquid. The drive motor shown has not been sized for any operation and so its size is an indication only. In some embodiments, the motor is mounted to keep it out of the waste liquid being processed; however, in other embodiments, the motor may be a submersible motor drive system allowing the whole RBR and drive assembly to be submerged.

In some embodiments, the system and/or apparatus includes a motor housing 812 which includes a structural housing to prevent damage to the motor during operation. In some embodiments, the system and/or apparatus includes a lifting mechanism such a lifting hook 813 illustrated in FIG. 18.

The lifting mechanism provides a mechanism for raising and lowering the RBR and/or drive system in and out of the bulk liquid to be processed. The motive force for raising and lowering can be provided by an external hoist or other mechanism incorporated, for example, into the system deployment structure.

In some embodiments, system and/or apparatus includes a telescoping member/unit for raising or lowering, or otherwise positioning the annular body into the volume of fluid.

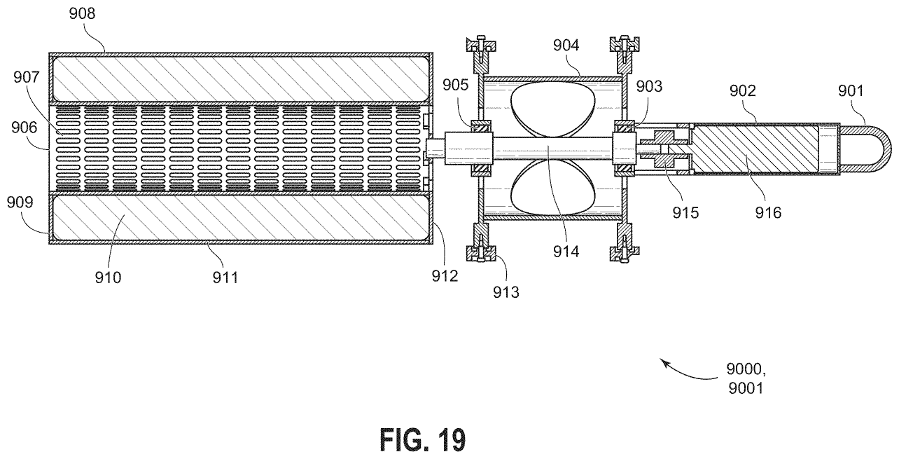

FIG. 19 shows a cross-sectional view showing aspects of an example apparatus 9000 and/or system 9001. In some embodiments, the example apparatus 9000 and/or system 9001 can include a lifting hook 901, a motor housing 902, a upper shaft bearing 903, an anti-rotation frame 904, a lower shaft bearing 905, an open lower central aperture 906, a perforated inner core 907, a perforated outer casing 908, a solid lower plate 909, exchange media (contained within the RBR) 910, a main body 911, a solid upper plate 912 including an open central aperture, anti-rotation roller bearings 913, drive shaft 914, drive shaft coupling 915, and drive motor 916.

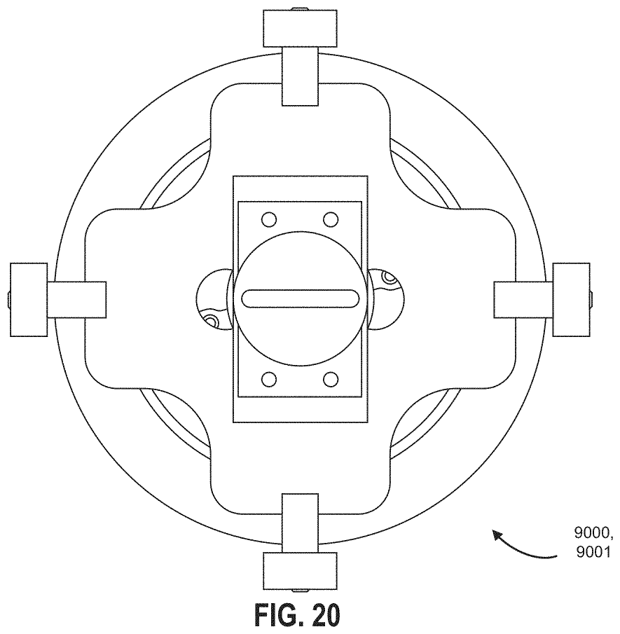

FIG. 20 shows a top plane view aspects of an example apparatus 9000 and/or system 9001

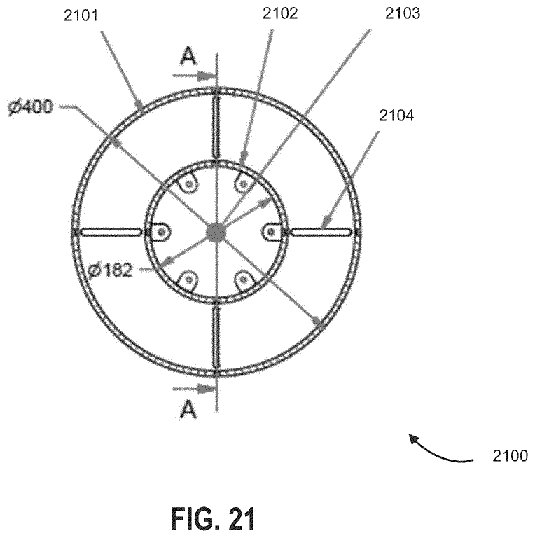

FIG. 21 shows a radial cross-sectional view showing aspects of an example apparatus 2100. This view shows examples of a perforated outer casing 2101, a perforated inner core 2102, an open lower central aperture 2103, and radial baffles 2104.

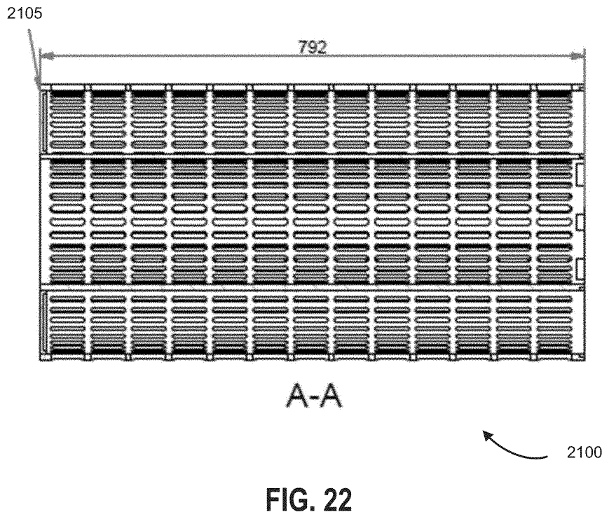

FIG. 22 shows an axial cross-sectional view showing aspects of an example apparatus 2100 taken a line A-A shown in FIG. 21. The lower plate is labelled as 2105

In some embodiments, the RBR is sized for a specific applications, for example, to provide a large RBR to fit through a given aperture (e.g. in a vessel opening and/or mast) and be small enough to fit within a 2001 litre drum for disposal. The RBR can be sized based on the requirements of other applications/deployments.

In some embodiments, the material for the majority of components will be chosen on the given application. In some embodiments, components such as those in the annular body are stainless steel for corrosion protection. In aggressive environments, for reuse and/or for larger RBRs, carbon steel can be used. In some embodiments, some components can be plastics, e.g. for example parts which are disposable, for example a cartridge system.

### Nuclear Tank Waste Application

In some embodiments, the rotating bed apparatus can be used to treat waste water stored in tanks contaminated with radioactive material such as radionuclides commonly produced by nuclear reactions in nuclear power plants and the like. The rotating bed apparatus can be inserted into the contaminated water via holes in the top of the storage tanks.

It should be appreciated that the ease of using the rotating bed apparatus to treat contaminated waste water stored in tanks increases when more of the following assumptions are true. Of course, none of the following assumptions are requirements for the use of the rotating bed apparatus in this or any other application.

Radiation levels are very low level such that manual intervention/operations are practical.

Sampling and analysis of treated water to be undertaken by site owner and/or before RBR deployment.

Access to the tanks where the rotating bed apparatus is deployed allows crane and truck travel. —Roads and areas of land around the tanks are available to be used by cranes and trucks during the operation of the rotating bed apparatus.

There is full personnel access to the top of the tanks and tank openings.

The tank access opening is at least 200 mm and preferably 600 mm.

The rotating bed units will be used once and will be disposed; they will not be refilled. —Each rotating bed apparatus can be used once and disposed or the media can be discharged and reloaded. Discharged media can be disposed of in high integrity containers or other suitable containers.

The rotating bed apparatuses can be disposed into 200 L drums (590 mm diameter, 900 mm height) with fully opening lids & band clamp locking lids.

Each rotating bed apparatus has dimensions of 800 mm high, 400 mm diameter (aspect ratio of 2:1).

The ion exchange media density is 700 kg/m³.

The rotating bed apparatus is spun inside the tank above the water level to remove excess water after processing.

The wetted or contaminated mechanical items, including the rotating bed unit, are covered with plastic or designed containers when removed from the tank for contamination control.

The rotating bed apparatuses are capable of being transported on a flatbed trailer approximately 2.5 m×12 m.

### Rotating Bed Apparatus Sizing

It should be appreciated that the rotating bed apparatus can have any suitable size. When used to treat contaminated waste water in a storage tank, the size of the rotating bed apparatus should be small enough to fit through the access opening on the top of the tank.

In one embodiment, the outside diameter of the rotating bed apparatus is no more than 600 mm to fit through the access opening (considering mechanical attachments and housings, approximately 400 mm). From a size standpoint, the dimension of the access opening is the main dimensional limitation for the rotating bed apparatus for in-tank treatment. In order to maximize the volume of ion exchange media, the dimensions for the rotating bed apparatus can have an aspect ratio of 2:1—e.g., H: 800 mm, OD: 400 mm. These dimensions have the added advantage that once utilized, the rotating bed apparatus can be transferred to a conventional 200 liter drum (approx. 590 mm×900 mm) for temporary storage and subsequent disposal.

The rotating bed apparatus can have any suitable ion exchange media capacity. In one embodiment, the capacity of the rotating bed apparatus can be at least as much as the minimum capacity for the ion exchange media of a fixed bed ion exchange system with the same media. In general, however, the loading capacity of the media is greater when used in the rotating bed apparatus compared to fixed bed ion exchange columns due to increased efficiency of the media usage and improved mass transfer effects.

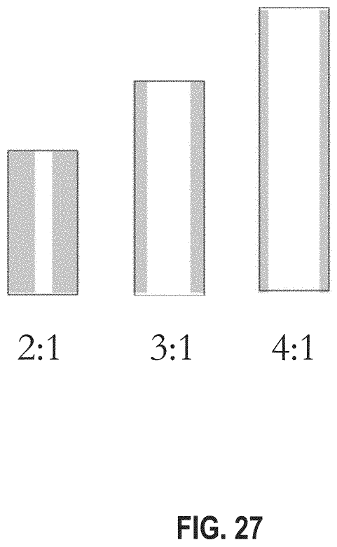

For a given bed volume of the RBR, different bed shapes may yield different flow rates and results. In testing, the 96 L RBR was stretched along its cylinder axis by a factor of 1.5 and 2, respectively. This yielded aspect ratios of 2:1, 3:1 and 4:1 (height: OD) as seen in FIG. 27. To keep the volume constant, the inner diameter was increased correspondingly, making the bed thinner. The flow rates for the three sizes at 200 rpm were found to be 11 m³/h, 32 m³/h and 52 m³/h respectively (FIG. 27) with the same bed resistance as before (1.0E10 m⁻²). From the table below, it can be seen that by adjusting the aspect ratio of the RBR to increase length or reduce bed depth, significant changes in flow rate through the RBR can be achieved.

| | Aspect ratio | | |
|---|---|---|---|
| | 2:1 | 3:1 | 4:1 |
| Flow rate | 11 m³/h | 32 m³/h | 52 m³/h |

In some embodiments, the exchange media and/or the aspects of the apparatus/system such as the annular body is configured to have a height to depth ratio based on the desired flow rate. In some embodiments, this ratio is also dependent on an aperture size through which the apparatus must be inserted (e.g. vessel opening or mast interior).

### Rotating Bed Apparatus In-Tank Deployment Option 1

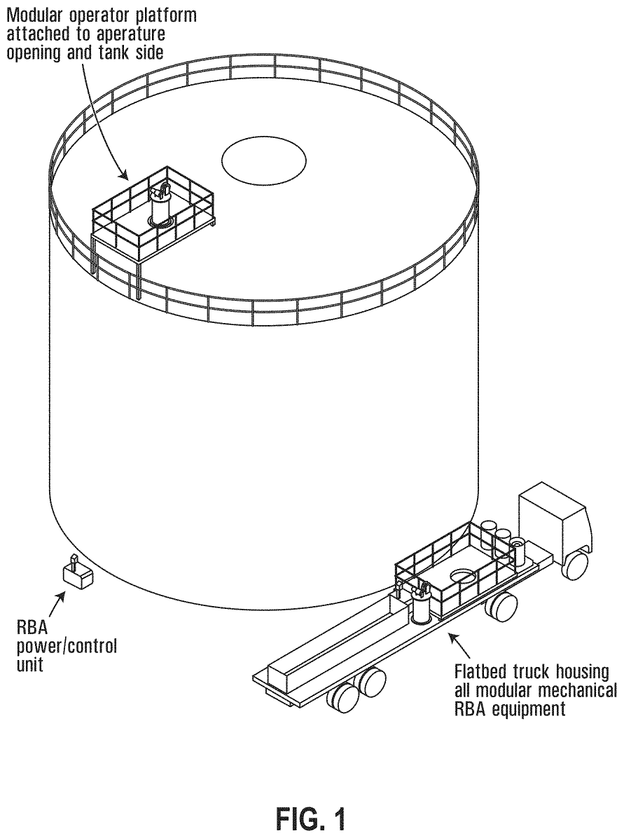

There are numerous ways that the rotating bed apparatus can be deployed in a storage tank to treat contaminated waste water. Two options are described in greater detail as follows. The first option is illustrated in FIGS. 1-4, which show perspective views of various components of the rotating bed system (also referred to as a rotating bed deployment system). This design utilizes a platform and more direct manual handling and operation.

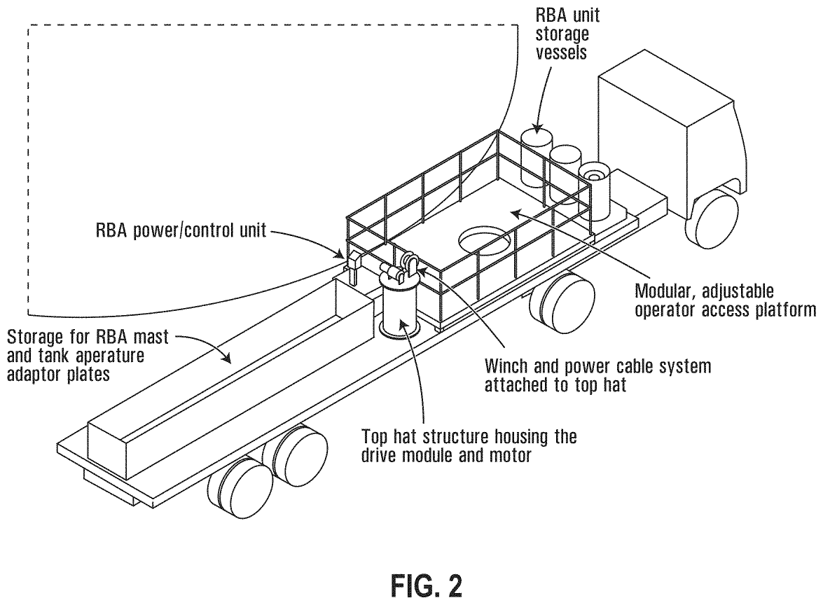

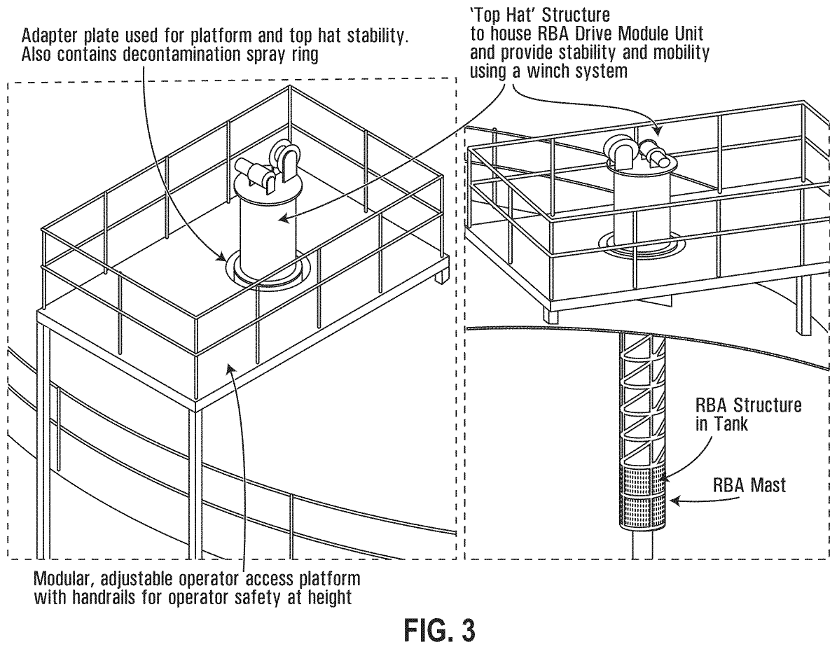

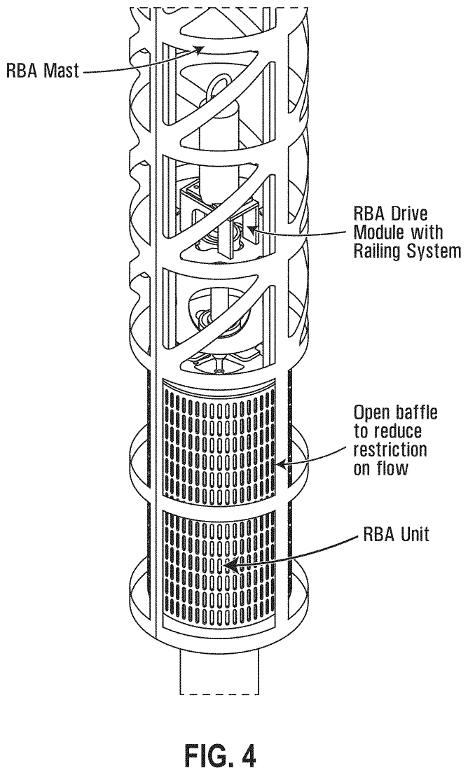

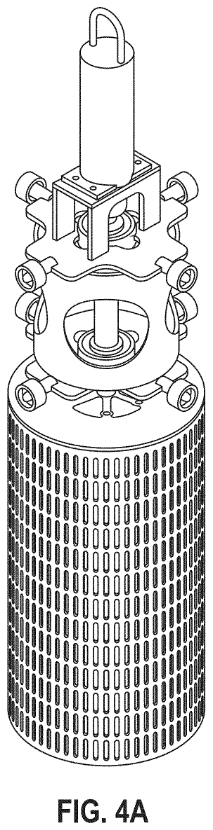

FIG. 1 is a perspective view of an example rotating bed deployment system for an in-tank waste treatment application. FIG. 2 is a perspective view of an example flatbed truck that can be used to house the modular mechanical equipment. FIG. 3 is a perspective view of an example access platform positioned on top of the tank and showing the RBA structure extending into the tank. FIG. 4 is a perspective view of an example RBA drive module unit within the mast (left side). FIG. 4A shows the RBA standing alone (right side). In some embodiments, a method for processing industrial effluent includes positioning, in a volume of fluid, a rotating bed apparatus comprising one or more chambers retaining exchange media; and rotating the rotating bed apparatus to facilitate fluid flow through the one or more chambers of the rotating bed apparatus.

In some embodiments, the method includes: positioning the rotating bed apparatus into the volume of fluid via an interior of a mast, the mast mountable on a support and extending towards or into the volume of fluid.

In some embodiments, the method includes: rotating the rotating bed apparatus in the volume of fluid at a first speed during a first time period to facilitate mixing of the volume of fluid, and rotating the rotating bed apparatus in the volume of fluid at second speed during a second time period to provide a residence time which enables exchange media ion exchange or absorption. In some embodiments, the speeds at which the RBA is rotated can be determined based on testing samples, as illustrated for example on the tests described herein., or otherwise.

In some embodiments, the method includes: supporting the rotating bed apparatus against the mast during rotation of the rotating bed apparatus. In some embodiments, the RBA is supported using an anti-rotational structure which can abut, or otherwise engage the mast or other structure.

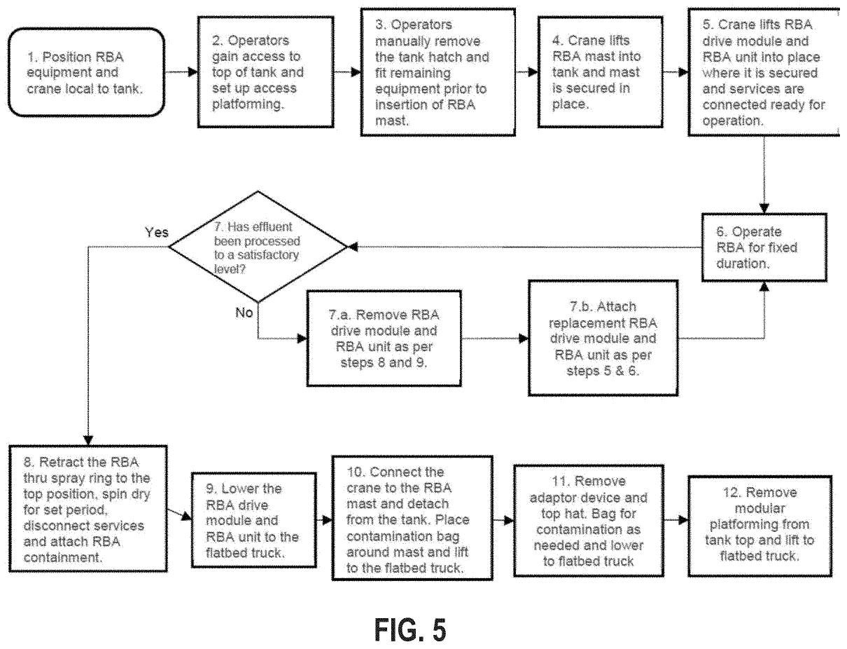

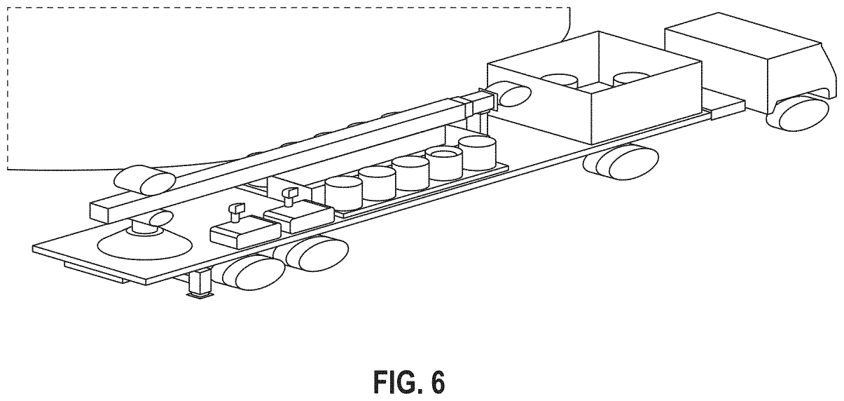

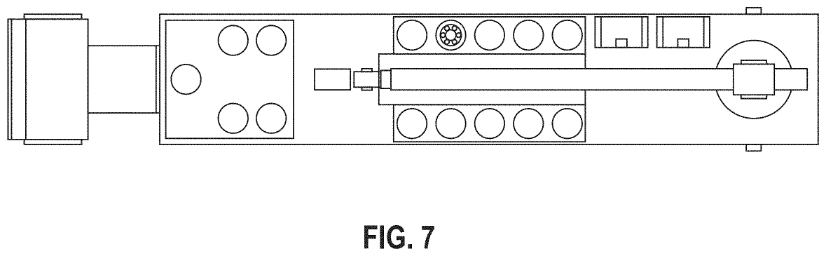

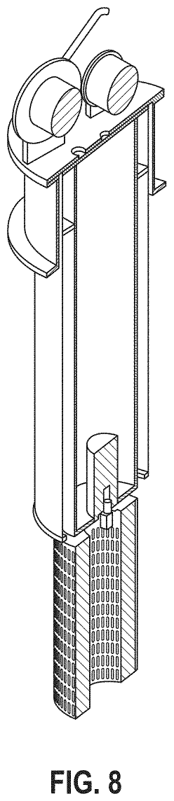

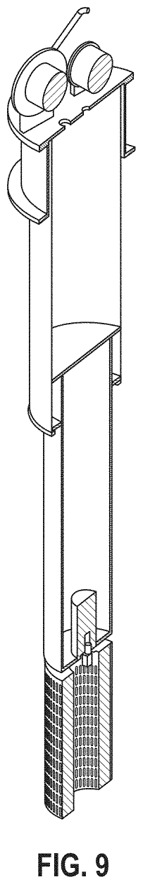

FIG. 5 is a flow diagram showing aspects of an example embodiment of a mechanical deployment sequence for the rotating bed system shown in FIG. 1. The sequence can include one or more of the following steps. Step 1: the RBA mast, tank aperture adaptor plates, RBA unit, top hat housing with RBA drive module, modular adjustable access platform, and required shielded containment are transported by flatbed to the tank location. Crane is set up for movement of equipment. Step 2: the tank top modular platforming with hand railings and housings is lifted and mounted atop the tank opening. Normal tank ladders are used for operator access. Support equipment, generator, water supply for spray ring and shielded container holding are positioned on the ground and connected as required.

Step 3: the tank hatch is manually removed. The tank aperture adaptor device (containing spray ring between tank opening and platform) is installed. Step 4: the RBA mast is lifted by crane, lowered into the tank through the aperture and secured to the adaptor device. The crane is then disconnected. Step 5: on the ground, the RBA unit is connected to the RBA drive module, which is housed within the top hat. This connected system is lifted to the adaptor device, where the top hat is then secured to the adaptor device. The services are connected for the winch and electric drive motor, the RBA unit is then lowered into the mast ready for operation.

Step 6: operate the RBA in the tank, processing the effluent for a fixed duration. Step 7: does the RBA require replacing to continue processing the effluent in the tank? If so, remove RBA drive module and RBA unit as per steps 8 and 9 and attach replacement RBA drive module and RBA unit as per steps 5 & 6. Step 8: raise the RBA drive module and RBA unit through the spray ring to the top position, spin dry within the tank, then disconnect services from winch and motor. Lift the top hat using the crane, detach RBA unit and place in containment. Step 9: lift the RBA drive module (housed in the top hat) and RBA unit to truck using the crane.

Step 10: attach the crane to the RBA mast and disconnect from the tank. Turn on spray ring, lift RBA mast through spray ring, out of tank. Bag the RBA mast for contamination control. Lift the RBA mast from tank and place onto truck. Step 11: detach tank aperture adaptor and place in bags for contamination control prior to lifting back into position on the truck. Replace tank hatch. Step 12: remove modular platforming from the tank top and place on truck for movement to next tank.

The RBA unit is connected to the motor via a drive shaft. The motor is housed within a drive module that guides the system inside the length of the RBA mast via a winch at the top of the top hat. The module has four wheels, 90 degrees apart, set into tracks in the RBA mast. When lowered to the bottom of the mast it connects to an open frame base container with an optional attached hose used for increasing flow distribution. The bottom of the mast has stops in each of the four wheel-channels to prevent the module from exiting the mast. Within the drive module is the submersible electric RBA drive motor. The drive motor power is supplied from the top of the mast by a retractable cable, mounted next to the winch. The drive and motor, with RBA attached, are raised and lowered by an electric winch, mast hoist, attached to the top of the mast.

When the ion exchange media needs to be replaced or the decontamination process is successful the RBA is removed. First the winch raises the motor-RBA system to the top most position. At the top, the system is fixed and sprayed to remove potential contamination. The RBA can be rotated to aid in drying the media and equipment. After allowing water to drip off the RBA and motor, it is wrapped to minimize contamination and placed into a shielded container using the crane. This is lowered to the ground for disposal. For continued processing another RBA unit is raised to the top of the tank, connected and the sequence restarts.

The process can include one or more of the following steps: Step 1: the mast hoist is used to raise the RBA drive module unit to the top hat structure and is fixed. Step 2: the unit is decontaminated with a spray in the top hat. Step 3: the unit is rotated to aid in water removal, time is allocated to allow for water to run off. Step 4: power to the motor is turned off and locked out, or disconnected. Step 5: the crane is attached and mast hoist is disconnected. Step 6: RBA drive module unit is wrapped to prevent contamination and lifted into shielded container on the platform. Step 7: crane disconnects from unit, container is sealed and crane is connected. Step 8: the crane lowers the RBA to the ground for disposal/decontamination/recycling. Step 9: the crane is then attached to another RBA unit on standby and the installation process repeats.

### Rotating Bed Apparatus In-Tank Deployment Option 2

This option is designed to minimize the radiation dose of the operating personnel. It is configured with fewer manual operations and increased remote operations and minimal site support requirements. This design has two main components, a mobile RBA Unit (MRU) with incorporated RBA placed in the aperture opening of the tank, supported by a single adaptor device. The second main component is the support trailer, 2.5 m×14 to 15 meters long. On the tail end of the trailer is a 3 to 5-ton hydraulic boom crane with adequate reach to access the top of the tank.

The trailer support unit can include one or more of the following: (1) generator to power the MRU, pump for spray ring, hydraulic crane, control systems and lighting, (2) hydraulic power unit for the crane, (3) storage container for transporting the MRU/RBA unit, (4) storage cells for new and used RBAs/drums, (5) shielded storage for used RBAs (if dose assessments indicate shielding is required), (6) fresh water storage tank and pump for spray ring in tank opening (RBA rinse for removal from tank), (7) control panel with CCTV monitors of RBA in the tank, and (8) enclosure for maintenance work and RBA exchange on MRU (the enclosure can be modified to provide the equipment to discharge exhausted RBAs and recharge for reuse; spent media is directed to the desired container.)

On top of the tank is the adaptor which can be adjusted for any tank opening. The adaptor includes a CCTV camera and light to view MRU operation. The adaptor has two slotted openings to accept two positioning lugs 180 degrees apart on the MRU which secure the MRU in place for operations.

The MRU is a two-piece telescoping unit with an upper section and lower section. The MRU is designed to place the RBA approximately one meter below the water level. Three offset lug configurations allow the MRU to be placed at three different depth levels for small variations in tank designs and water levels. The lower section contains the RBA and motor in a fixed position. The top of the lower section is used as the lifting point inside the upper section. Two cables extend through the top of the upper section and pull the lower section up into the upper section until both sections lift. This feature eliminates the need for a separate RBA winch. The upper section contains the spray ring to rinse the wetted portions of the lower section when lifted out of the water.

MRU deployment and operation can include one or more of the following steps. Step 1: support trailer is located next to the tank for processing. Step 2: support trailer out riggers are extended for crane operations. Step 3: generator or site power is started/connected, hydraulic unit started. Step 4: the tank lid is removed by personnel on the tank using the support trailer crane, if needed. Step 5: crane lifts the adaptor to the tank opening for installation, light and camera connections completed. Step 6: the MRU is prepared with a newly loaded RBA, power and water line connected, RBA cover placed on MRU (RBA cover can be a container specially fitted to completely cover the RBA and wetted portions of the MRU for movement to and from support trailer and tank, contamination protection.) Step 7: the MRU is lifted to the tank opening, the RBA cover is removed and secured to a stand on the side of the adaptor, the MRU is placed in the adaptor to the proper depth/lug setting. It is ready for operation.

The MRU can be removed or the RBA replaced using one or more of the following steps. Step 1: the crane is attached to the MRU. Step 2: as the crane lifts the lower section the spray ring is activated for rinse down, RBA is spun to remove water, operations are monitored by CCTV. Step 3: the MRU is lifted out of the adaptor and immediately lowered into the RBA cover next to the opening, personnel secure the cover in place (remote operation is possible to avoid personnel on the tank each time). Step 4: the MRU with RBA cover is lowered to the support trailer enclosure for RBA replacement and or placed in the storage container for movement to the next location. Step 5: the MRU is moved back to the top of the tank for processing or, the crane is used to remove the adaptor from the top of the tank. Step 6: the tank lid is replaced with crane assist if needed, crane boom parked in travel position on trailer. Step 7: all electrical, service water connection, lights and cameras connections removed. Step 8: support trailer outriggers retracted. The trailer and MRU are now ready to move.

The MRU requires minimal outside support and can be installed and operational within hours. Process times are the same as those described elsewhere in this document. However, as mentioned, additional units would increase the processing efficiency. One support trailer can provide the necessary services for multiple operating MRUs. The batch process tanks are preferably near a roadway where the support trailer crane can reach. Again, processing tanks as groups using one or two tanks in each group as batch processing tanks.

The MRU design is simpler, less expensive per unit and easier to maintain. Lower cost per unit allows for more process units within the same budget. The MRUs can be used for other projects upon completion of the waste water tank farm.

It should be appreciated that numerous other RBA designs can be used to remove radioactive contaminants from waste water. Examples of additional RBA designs include any of those described in the patents incorporated by reference at the end of the description.

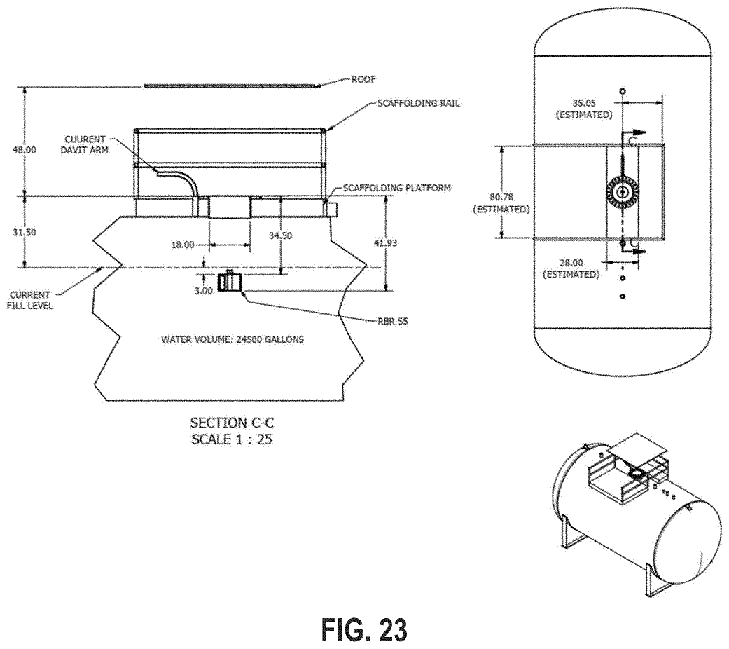

FIG. 23 shows aspects of an example supporting structure positioned over a vessel containing a volume of fluid. In some embodiments, the system can be configured to operate under a building housing the vessel. This is a representation of an example engineered system for deploying a small 10 L RBR in a 100 m³ tank that has restricted access. It is not uncommon to encounter access restrictions when processing stored nuclear waste and in some embodiments, engineered solutions can be used to deploy the RBA overcomes those restricted access issues.

In some embodiments, the handling limit of the system may be limited by the headroom above the vessel. For example, if a manual handling limit is less than 20 lbs, and a filled RBR is 80 lbs, the system can be configured to avoid this limit.

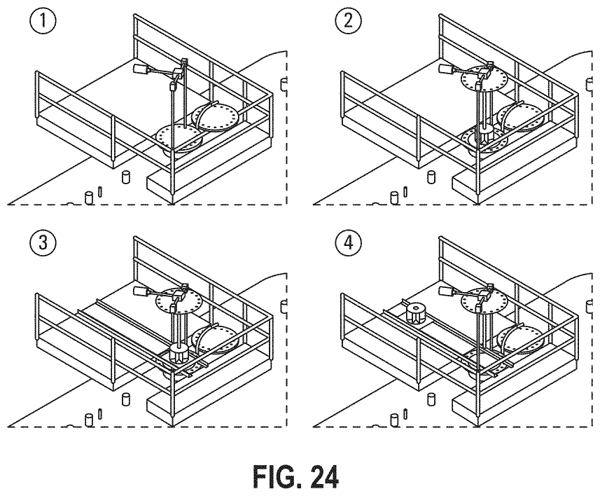

FIG. 24 shows an example system/method where assembly of the RBR, motor and driveshaft unit occur on top of the tank. Screwjacks and a trolley can be used to maneuver the RBR, a pulley may be required to raise the parts from the ground up to the tank.

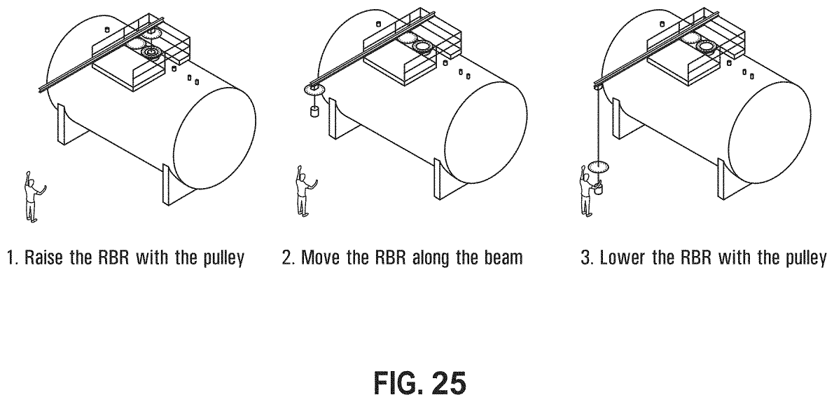

FIG. 25 shows an example system/method where assembly of the RBR, motor and driveshaft unit occur on the ground. A runway beam can be used to move the unit into position with a pulley providing the vertical lift. In some embodiments, a modular/telescopic drive shaft can be configured to realixe the runway beam solution.

### EXAMPLES

The following examples are provided to further illustrate the disclosed subject matter. They should not be used to constrict or limit the scope of the claims in any way. A series of experiments were performed using a laboratory-scale S3 Rotating Bed Reactor (RBR) to assess the suitability of using a rotating bed apparatus in nuclear applications. The experiments were performed to evaluate media stability and the RBR performance in solutions of interest to the nuclear industry.

In some situations, the RBR may be used for applications in the biotechnology and pharmaceutical sectors. The RBR device retains the solid phase as a packed bed inside a rotating cylinder. As the RBR spins, a continuously circulating flow develops. Reaction solution is rapidly aspirated from the bottom of the vessel, percolated through the solid phase and quickly returned to the vessel. The resulting efficient mass transfer minimizes treatment time, boosts material capacity and increases process flow rates.

The tests were performed to evaluate the suitability of using a rotating bed containing ion exchange and adsorption media for the remediation of liquid radioactive effluents at various sites in the world. The aim of the tests was to assess the performance of the RBR using several media and to investigate media stability, reaction kinetics, the impact of suspended solids and the effect of rotation speed.

### Materials and Equipment

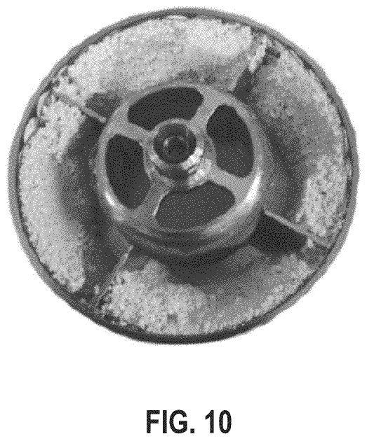

The RBR includes a stirring mechanism and was positioned in a 1 liter reaction vessel. FIG. 10 shows a top perspective view of the RBR containing granular media (after spinning for 5 hours). Note how the centrifugal force generated during operation has forced the media outwards onto the outer screen.

The RBR was used for all experiments. It has an outer radius of 33.5 mm, an inner radius of 18.1 mm and a height of 29.5 mm and is divided into four separate compartments. The inner and outer walls are fitted with a 100-micron screen to retain the media. The theoretical total volume available to fill with media is approximately 73.6 cm3 or 18.4 cm3 per compartment but in practice, the compartments would be filled with less media to allow for swelling.

The effective bed depth, i.e. the distance between the inner and outer screens, is 15.4 mm. The empty bed contact time (EBCT) during operation will therefore only be a matter of a few seconds at most and thus multiple passes through the media will be required to remove a contaminant completely. This contrasts with a fixed bed system where the EBCT is typically between 3 and 5 minutes and has the aim of removing the contaminant in a single pass.

In effluents containing a contaminant present as multiple species in equilibrium (e.g. Ru106 in the Fukushima wastes), the RBR in theory allows a better removal to be achieved. This is because the system is closed and if one species in equilibrium is removed, the system will reequilibrate generating more of the species amenable for removal by the resin/adsorbent in the RBR.

### Example 1

### Media Attrition

Significant forces are generated during the operation of the RBR which drive the flow of liquid through the RBR. One concern was that operation of the RBR could damage granular media, especially ones that are known to have a low attrition resistance. To test this, a sample of Cs-Treat was used to investigate media stability. This particular media is a granular hexacyanoferrate manufactured by Fortum, Finland that can be used to selectively remove Cs-137 from liquid wastes generated, for example, from the ongoing cooling operations of the damaged reactors at Fukushima. Although highly effective at removing Cs-137 in the presence of other competing ions, Cs-Treat has very poor physical strength which has caused operational problems in fixed column systems at multiple sites (e.g. Fukushima, Bradwell). This probably represents the worst-case scenario in terms of media stability.

The as-received Cs-Treat contained large amounts of fines (as is typical with Cs-Treat). These were removed via repeated washing with tap water and the media was then wet sieved using a 300 p.m sieve to remove small particles before being dried at approximately 40° C.

5 g of the washed Cs-Treat was placed in each of the four compartments within the RBR. The RBR was sealed and the axle was attached and connected to the stirrer motor. The RBR assembly was lowered approximately half way into a 4 liter beaker containing tap water. The stirrer was turned on and set to 500 rpm. Any changes to the water clarity were noted as the experiment progressed.

In total, the RBR was spun for 13.25 hours over a two-day period with 5 stop-start cycles spread between the two days to simulate what may happen in actual use. It was noted that within a couple of hours from the start, the water in the beaker turned a light brown color. This was then changed and fresh water added. However, as the experiment progressed, the water continued to turn brown despite being changed another three times during the 13.25 hours of the experiment.

This brown color indicated that media attrition was occurring.

The experiment was repeated using a rotation speed of 250 rpm as opposed to the original 500 rpm. This would cause a reduction in pressure but would also likely increase the time required to remove a contaminant from a waste solution. The media was spun for a total time of 12.75 hours, again over a two-day period, this time with a total of 6 stop-start cycles. The water still turned a light brown color during the experiment, but it was noticeably less than during the 500-rpm experiment and seemed to decrease as the experiment progressed suggesting that some of the fines may have been generated during the loading of the RBR, possibly due to trapped grains of Cs-Treat being crushed during the RBR assembly.

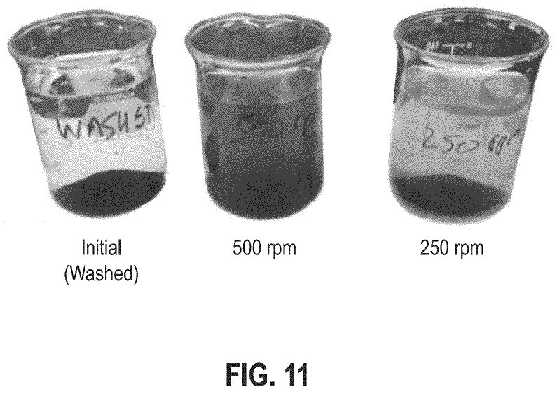

After completion of each experiment, the contents of the RBR was washed into a beaker of water to assess the fines content. A picture of the media from both experiments is shown in FIG. 11. It is clear from FIG. 11 that there was considerable degradation of the media during the 500 rpm experiment compared to the initial media (left of photograph). Cs-Treat degradation at 250 rpm has been minimal and the media would probably be considered clean enough for use in a fixed bed ion exchange system.

Cs-Treat is known to be unstable in distilled or deionized water but it was assumed that ordinary tap water would contain sufficient dissolved salts to maintain the stability of the granules.

However, this assumption was tested by repeating the stability experiment using a solution of 10,000 mg/l NaCl in the beaker as opposed to tap water. The RBR was loaded with 5 g of washed Cs-Treat per compartment and spun at 500 rpm as done previously. However, this time the liquid remained crystal clear from the start of the experiment until it was terminated after 4 hours. Examination of the Cs-Treat after 4 hours showed absolutely no evidence of media degradation. Additional tests indicated that similar salt solutions prevent media attrition at speeds up to 1000 rpm.

The media attrition tests indicate that the stability of Cs-Treat is dependent upon the composition of the liquid it is being spun on. Thus, for relatively low ionic strength solutions, it would be necessary to test the stability prior to any system deployment. However, it appears that if there are sufficient salts dissolved in the liquid being treated, Cs-Treat is stable in the RBR.

A similar attrition resistance experiment was also performed using a coconut-derived Granular Activated Carbon (GAC). The GAC was washed to remove fines and 5 g of material was placed in each of the four compartments within the RBR. The system was then placed into a 4 liter glass beaker containing tap water and spun for a total of 13.5 hours over a two-day period at a speed of 500 rpm with three stop-start cycles per day. No evidence of fines release into the water was observed over the entire two days and examination of the GAC in the RBR at the end of the experiment showed no evidence of fines generation or media attrition.

### Example 2

### Media Washing and Dewatering

One possible application of the RBR is washing and dewatering the media. Many of the granular media used in the nuclear industry require extensive washing to remove fine particulates before they can be put on-line in a water treatment system. Without the washing step, the fines can cause partial blocking of the media columns, resulting in a high-pressure differential across the media bed and poor hydraulic flow through the media. Fines containing radioactivity may also be released by the media bed causing problems elsewhere throughout the water treatment system. The washing procedure may take hours and lead to the generation of large volumes of waste that requires disposal.

Tests demonstrated that by placing dirty media in an RBR and pulsing for a few seconds, it was possible to remove the bulk of the fines from a sample of GAC. It was also investigated whether Cs-Treat could be cleaned in a similar manner.

5 g of unwashed Cs-Treat was placed in each compartment of the RBR and the RBR immersed in tap water in a 4 liter beaker. The system was then pulsed 4 times, each pulse lasted approximately 5 seconds, at a speed of 590 rpm over a period of about 1 minute. Lots of fines were released into the water. Additional experiments showed that there was no further release of fines after the initial 4 pulses and that changing the rotation speed had no real effect on the washing procedure.

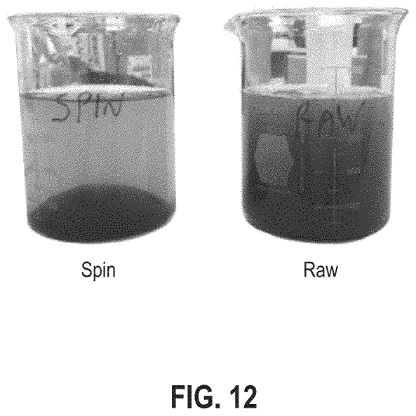

FIG. 12 shows a picture of the Cs-Treat after pulsing in comparison with the original unwashed Cs-Treat. It can clearly be seen that the pulsing has removed the bulk of the fines originally present in the Cs-Treat. The residual fines would probably not impact the media performance and, importantly, the additional experiments suggested that they were not likely to be released during continued operations and remained trapped in the RBR. This potentially offers a method by which media loaded into a rotating bed apparatus could be washed quickly prior to being placed in use, minimizing the volumes of wash waters generated.

### Example 3

### Spin Speed

The effect of spin speed on the performance of the RBR was studied using a red dye, (Allura Red) and a strong base anion exchange resin (EnergySolutions, CN 100). The effective contact times between the media and the water passing through the RBR are exceedingly short, just a matter of a few seconds, and this decreases as the spin speed increases. Ultimately, the contact time may become too short for the contaminant (in this case, the Allura Red dye) to interact effectively with the active adsorption sites on the media with the uptake being limited by the mass transfer rate between the liquid and the solid adsorbent. Thus, there may be a limit beyond which increasing the spin speed fails to improve the removal kinetics. This assumption was investigated in the following series of experiments.

5.0 g of resin was loaded into each compartment within the RBR and the RBR placed inside the baffled 1 liter reactor. 1 liter of a 40 μM Allura Red solution (0.02 g/l) was added and the RBR turned on at a designated spin speed. The time taken for the red color to completely disappear from the solution was recorded. The spin speed was varied from 200 rpm to 600 rpm using fresh dye solution for each experiment.

Assuming the resin beads are approximately 400 μm in diameter, the volume passed through the reactor at each spin speed can be calculated during the experiments. The results are shown below in Table 1.

TABLE 1
Spin speed results

| | Time | | Total Vol. | Number of |
|---|---|---|---|---|
| | Until | Appr. | Passed | Reactor |
| Spin | Color | Flow | through | Volumes |
| Speed | Eliminated | Rate | RBR | Processed |
| (rpm) | (s) | (ml/s) | (ml) | in Test |
| 200 | 967 | 12 | 11604 | 11.60 |
| 300 | 460 | 24 | 11040 | 11.04 |
| 400 | 474 | 42 | 19908 | 19.91 |
| 500 | 360 | 66 | 23760 | 23.76 |
| 600 | 384 | 91 | 34944 | 34.94 |
| | | (estimated) | | |

Table 1 shows that the efficiency of dye removal is greater at the lower spin rates when the dye solution has a longer contact time with the resin beads. At both 200 and 300 rpm, it takes approximately 11 passes through the resin to remove all the dye. As the spin speed increases, the flow rate increases and thus the contact time between the resin and dye molecules decreases resulting in a less efficient dye removal and consequently more passes through the resin to completely remove the dye.

In terms of the time taken to remove the dye, it appears from the results that increasing the speed beyond 600 rpm is likely to cause a limited improvement (if any at all) in the time taken to remove the dye. Increasing the speed also increases the pressures generated thus increasing the chances that the more fragile media could be damaged so there is little incentive to investigate higher spinning speeds.

A fixed bed system using the same amount of ion exchange resin would take considerably longer than any of the times taken using the RBR. Assuming a 3-minute contact time for the resin and a bulk density of 700 g/l for the anion exchange resin, a rough estimate can be made of the time required to process one liter of dye solution. 20 g of resin is equal to a volume of 28.6 ml thus to get a 3-minute EBCT, the dye would need to be passed through a column of resin at a flow rate of 9.53 ml/min meaning it would take approximately 105 minutes to treat the one liter of dye solution.

### Example 4

### Effect of Suspended Solids

A conventional fixed bed ion exchange resin system used for water treatment generally require the incoming water to be essentially free of suspended solids. If the incoming water contains significant levels of suspended solids, then they are filtered by the ion exchange media resulting in pressure build up across the media columns and poor hydraulic flow which may result in premature media replacement. Since the RBR has a very short effective bed depth, it is believed that fines would not be held as effectively resulting in a greater tolerance of suspended solids and reducing or eliminating the need to filter the incoming water. The effect of solids was investigated using Allura dye solutions containing montmorillonite clay.

3 liters of distilled water was placed in a 4 liter beaker and 5 g of montmorillonite clay was added. The mixture was stirred vigorously for several hours to disperse the clay and then left overnight. 0.06 g of Allura dye was added and the mixture was stirred vigorously until all the dye was dissolved. (The montmorillonite clay is a cation exchange material with a negative charge and will not interact with the Allura dye which also has a negative charge. Thus, the effect of the solids on the dye removal by the anion exchange resin should be able to be assessed.)

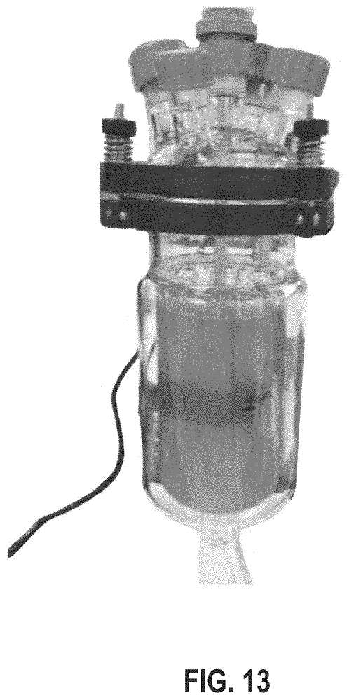

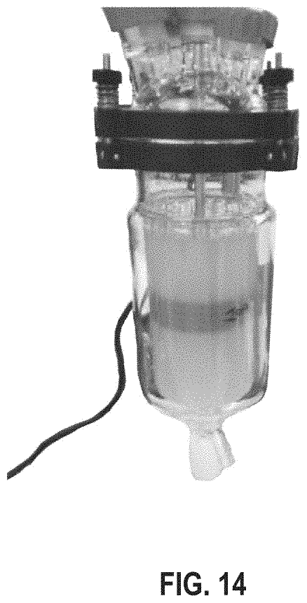

1 liter of the dye/clay mixture was placed into the 1 liter glass reactor vessel. The RBR was lowered into the mixture and a spin speed was selected. The time taken for the dye to be completely removed (based upon visual observation) was recorded. Pictures of the mixture before and after the completion of the experiment are shown in FIGS. 13-14.

It took approximately 12 minutes to remove the dye at a spin speed of 300 rpm and approximately 8 minutes at a spin speed of 500 rpm. Both times are greater than the removal time for the dye solutions alone and suggest that the presence of the clay particles may have physically inhibited removal of the dye by the resin. Examination of the RBRs after the experiments indicated that very little, if any, clay was retained by the media which confirms the initial belief that this would not occur due to the short effective bed depth of the resin in the RBR. It should be noted, however, that the effective bed depth will increase significantly when a larger rotating bed apparatus is used making it more likely to act as a filter and thus be more influenced by suspended solids. However, even if this is the case, it is likely to be less affected than a comparable fixed bed media system.

### Example 5

### Effect of Settled Solids

Many nuclear wastes (e.g. DOE HLW tanks) contain a settled sludge at the bottom of the tank. Thus, it would be desirable to use the RBR at a slow enough speed to avoid turbulence and not disturb the settled sludges. This possibility was investigated using a ferric hydroxide (Fe(OH)3) sludge. 3 liters of distilled water was placed in a beaker and 6 ml of a 40% solution of ferric chloride, FeC13, added. The pH was then adjusted to 5.83 using 1N sodium hydroxide generating a large amount of fine brown ferric hydroxide precipitate. This was allowed to settle and the RBR positioned towards the top of the water level. Even at the lowest possible speed setting (50 rpm) significant turbulence was generated during the operation resulting in the disturbance of the sludge layer. Thus, it was not possible to assess the effectiveness of operating the RBR using the facilities available at the laboratory. However, this does not mean that it would be impossible under other conditions (e.g. slower rotation speed, greater height of RBR above the sludge layer). This experiment did demonstrate that the RBR causes good mixing in the vessel, even at very low spin speeds.

### Example 6

### Large Volume Dye Trial

The initial dye removal experiments were performed in a glass reactor vessel optimized to work with the RBR. This vessel was designed to minimize the formation of vortexes and maximize the efficiency of the RBR. This situation is unlikely to be encountered in any large-scale field applications so work was performed using a non-optimized rectangular tank. In this experimental set-up, the performance would be expected to be less efficient due to poorer mixing within the tank and be a fairer representation of conditions likely to be encountered in actual fullscale applications.

20 liters of distilled water was placed in a rectangular tank and 0.4 g of Allura Red dye was added. The mixture was stirred thoroughly using a conventional overhead stirrer until all of the dye dissolved and the solution was a uniform color. 5 g of anion exchange resin was loaded into each compartment of the RBR and the RBR was positioned approximately in the center of the tank. The speed was set to 500 rpm and the system turned on. No significant vortex was noticed during the operation of the RBR and all the dye was judged to have been removed after 2 hrs and 24 minutes. Using the optimized glass reactor, it took the same volume of resin 6 minutes to remove the dye from 1 liter of solution. Thus, assuming a direct scale-up, it would have been expected to take 2 hours to treat 20 liters under optimized conditions. Thus, the use of a non-optimized rectangular tank did not significantly decrease the RBR efficiency.

Examination of the resin beads under a microscope at the end of the experiments showed them to be almost completely uniformly colored indicating good utilization of the available resin capacity. When operated to resin exhaustion, this uniform utilization would be expected to translate into decreased media usage compared to a conventional fixed bed system.

### Example 7

### Simulated Nuclear Tank Waste and GX-194 Media

The kinetics data generated from the Allura dye experiment was utilized to design a test relevant to an example of nuclear tank waste—i.e., the Fukushima tank waste. 20 liters of distilled water was placed into the rectangular tank and 179.75 g of artificial seawater salt was added. This represents about 25% of regular seawater strength and is representative of some of the early Fukushima waste tank compositions. The mixture was then stirred thoroughly to dissolve the salt, though it was noticed that a very small amount of solids did not dissolve and remained at the bottom of the tank. This residual solid probably accounted for <0.5% of the total added salts. The solution was spiked using 10 ml of a 1000 mg/l solution of antimony to give a total concentration of approximately 500 μg/l. The pH was adjusted to 7.69 using a small amount of 1N NaOH solution to neutralize the nitric acid present in the antimony standard. A sample was analyzed for Sb.

The RBR was loaded with 32 g of washed GX-194 media (8 g per compartment), placed in the center of the tank and spun at a speed of 500 rpm for 5 hours. 50 ml samples were taken every 30 minutes and later analyzed to determine the antimony content. The pH of each of the samples was also recorded. The results are shown below in Table 2.

TABLE 2
simulated nuclear tank waste antimony
removal with GX-194 media

| Time | | Antimony | Antimony |
|---|---|---|---|
| (min) | pH | Concentration (μg/l) | Removal (%) |
| 0 | 7.69 | 394 | 0 |
| 30 | 7.46 | 89.8 | 77.2 |
| 60 | 7.47 | 34.8 | 91.2 |
| 90 | 7.38 | 24.1 | 93.9 |
| 120 | 7.38 | 19.6 | 95.0 |
| 150 | 7.33 | 22.2 | 94.4 |
| 180 | 7.43 | 12.1 | 96.9 |
| 210 | 7.46 | 7.1 | 98.2 |
| 240 | 7.44 | 8.8 | 97.8 |
| 270 | 7.46 | 11.4 | 97.1 |
| 300 | 7.45 | 12.0 | 97.0 |

The initial antimony concentration was expected to have been closer to 500 μg/l. The lower than expected concentration of 394 μg/l could be due to either laboratory error or the adsorption/precipitation of antimony in the 20 liter tank, though given the solubility of antimony salts, the latter is unlikely. Antimony removal appears to initially be very rapid with the concentration reduced from 394 μg/l to 84 μg/l in just 30 minutes. After that, the reduction in antimony is much slower and there is very little difference between the samples from 180 minutes through the end of the experiment at 300 minutes.

The variation in antimony concentration between 180 minutes to 300 minutes may be due to either analytical variation or non-homogeneity of the tank water resulting in slight variability of the antimony concentration throughout the tank. The analytical detection limit was 5 μg/l so concentrations of antimony after 180 minutes were getting close to the limit. (This potential nonhomogeneity was investigated in a later radioisotope experiment by taking multiple samples for analysis from different locations within the tank at the same time interval and it was found that the concentrations within the tank were very consistent.) The rate of removal of the antimony seems to have been similar to the dye experiment in the same tank when all of the dye was judged to have been removed after 144 minutes.

The water flow through the RBR was estimated to be approximately 66 ml/s in Example 3 (see Table 1), though the flow rate through the GX-194 would be expected to be a little slower than through a standard ion exchange bead due to the granular nature of the media and the smaller particle size. However, using this flow rate as a maximum, after 30 minutes, 118,800 ml or 118.8 liters of liquid passed through the RBR and consequently through the GX-194 media. This represents almost 6 times the volume of the 20 liter tank so it is clear that much of the antimony removal is during the first few passes through the media. Presumably the surface sites of the GX194 get saturated with antimony and thus the removal rate decreases as the antimony has to migrate into the media to adsorption sites deeper within the granules.

### Example 8

### Simulated Nuclear Tank Waste and Cs-Treat Media

20 liters of distilled water was placed into a rectangular tank and 179.75 g of artificial seawater salt added. This represents about 25% of regular seawater strength and is representative of some of the early Fukushima waste tank compositions. The mixture was then stirred thoroughly to dissolve the salt, though it was noticed that a very small amount of solids did not dissolve and remained at the bottom of the tank (as was also seen with the antimony experiments). As in the previous antimony experiment, this residual solid probably accounted for <0.5% of the total added salts. 0.0283 g of CsCl was then added to give a total cesium concentration of approximately 1 mg/1 and the mixture stirred for an additional 3 hours to ensure the cesium was evenly dispersed.

The RBR was loaded with 20 g of washed Cs-Treat (5 g per compartment), placed in the center of the tank and spun at a speed of 350 rpm for 5 hours. 50 ml samples were taken every 30 minutes and later analyzed to determine the cesium content. The pH of each of the samples was also recorded. At intervals during the course of the experiment, two separate samples (A and B) were taken from opposite sides of the tank at the same time interval to check for solution homogeneity. A sample of the solution prior to starting the experiment was also sent for analysis. The results are shown in Table 3.

TABLE 3
Simulated nuclear tank waste cesium removal with Cs-Treat media

| Time | | Cesium Con. | | Cesium Removal |
|---|---|---|---|---|
| (min) | pH | (μg/l) | DF* | (%) |
| 0 | 7.55 | 1000 | 1.00 | 0 |
| 30 (A) | 7.63 | 498 | 2.01 | 50.2 |
| 30 (B) | 7.67 | 478 | 2.09 | 52.2 |
| 60 | 7.74 | 227 | 4.41 | 77.3 |
| 90 | 7.79 | 108 | 9.26 | 89.2 |
| 120 | 7.83 | 55.3 | 18.1 | 94.5 |
| 150 | 7.77 | 33.6 | 29.8 | 96.6 |
| 180 (A) | 7.81 | 21.2 | 47.2 | 97.9 |
| 180 (B) | 7.86 | 22.0 | 45.5 | 97.8 |
| 210 | 7.82 | 16.1 | 62.1 | 98.4 |
| 240 | 7.81 | 13.1 | 76.3 | 98.7 |
| 270 | 7.77 | 10.7 | 93.5 | 98.9 |
| 300 (A) | 7.74 | 9.47 | 106 | 99.1 |
| 300 (B) | 7.74 | 8.94 | 112 | 99.1 |

Decontamination Factor (DF) = initial concentration divided by the concentration at a given time.

The initial cesium concentration was exactly 1000 μg/l (1 mg/l ) indicating that, as expected, there was no precipitation when the cesium chloride was added to the simulant solution and there was no adsorption onto the sides of the tank. Cesium removal was initially rapid and the concentration was reduced by approximately 50% within the first 30 minutes of the experiment. However, once the bulk of the cesium was removed, further removal of the trace amounts left in solution was relatively slow and it took 2 hours to reduce the concentration from 22 μg/l to 9 μg/l when the experiment was terminated. Additional cesium removal may have occurred if the experiment had been allowed to run longer, but the rate of the cesium decrease was diminishing so there was little to be gained by continuing to run the RBR.

It is worth noting that this experiment was run at a lower speed than the previous experiment using GX-194 when the speed was 500 rpm. The rate of decrease for the GX-194 experiment was initially quicker (77% removal of antimony within the first 30 minutes) but then decreased over time and antimony was reduced to similar levels as the cesium at the end of the experiment.

The analysis of the duplicate samples showed relatively little difference between the A and B samples. This indicates that the tank is homogenous, suggesting the rotation of the RBR was sufficient to adequately mix the tank contents. There was also no evidence of any release of Cs-Treat fines suggesting that the forces generated during the RBR operation did not cause any degradation of the media.

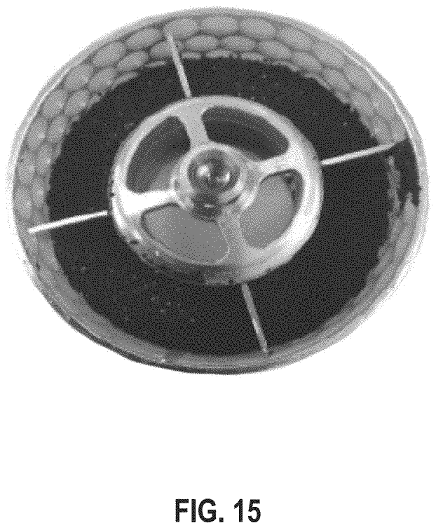

A photograph of the Cs-Treat media in the RBR after the completion of the experiment is shown in FIG. 15. The media appears to have dewatered better than the GX-194 and settled to the bottom of the RBR. When the media was removed from the RBR and examined, there was no evidence of any fines generation confirming that the Cs-Treat was stable during the experiment. It is also worth noting that even though the RBR was only partially filled with Cs-Treat, the analytical data clearly demonstrated that the water was passed through the Cs-Treat effectively.

### Radioactive Testing

Following the successful testing using non-radioactive species, radioactive experiments were performed to confirm the performance of the RBR using radiotracers and to generate data relevant to nuclear waste such as that found at Fukushima. Radioanalytical analyses were obtained using the following instruments: PerkinElmer 2480 Automatic Gamma Counter Wallac Wizard 3; Gamma Detector (Cesium and Strontium)—Reverse-Electrode Coaxial Germanium Detector (Carbon Composite Window), Canberra 1993 Model Number: GR3520; Gamma Detector (Iodine)—Low Energy Germanium Detector (Carbon Composite Window), Canberra 1992. Model Number: GL2020-S;

During some of the experiments, 5-10 ml liquid samples were taken periodically to track the rate of isotope removal. These samples were analyzed using the Wizard 3 using a 10-minute counting protocol to obtain raw counts per minute (cpm) data. Initial and final samples were counted on the appropriate calibrated germanium detectors to get absolute values of activity. The properties of the isotopes used during the radioactive testing are shown in Table 4.

TABLE 4
Isotope characteristics

| | | | Specific Activity | Specific Activity |
|---|---|---|---|---|
| Isotope | Half Life | | (Ci/g) | (Bq/g) |
| Sr-85 | 64.85 | days | 2.4 × 10⁴ years | 8.9 × 10¹⁴ years |
| I-125 | 60.14 | days | 1.7 × 10⁴ years | 6.3 × 10¹⁴ years |
| I-129 | 1.7 × 10⁷ | years | 1.6 × 10⁻⁴ years | 5.9 × 10⁶ years |
| Cs-137 | 30.2 | years | 88 | 3.3 × 10¹² years |

### I-125 Testing—Examples 9-12

1 mCi of carrier-free I-125 in 10-5M NaOH was obtained from PerkinElmer. This isotope has a half-life of 60.14 days and decays via electron capture and the emission of a low energy gamma ray (35.5 keV) to Te-125. These favorable decay characteristics and availability allowed it to be a good surrogate for the long-lived I-129 found in the nuclear tank waste such as that found in the Fukushima waste tanks.

The product received from PerkinElmer was diluted to a total volume of 5 ml using 10-5M NaOH to allow easier handling. The diluted solution was used to spike all the experimental solutions. For all of the I-125 experiments, the matrix used was 5% seawater. This was synthesized from a synthetic seawater concentrate purchased from a pet store diluted to 5% of the recommended concentration.

### Example 9-I-125 Kinetics

20 liters of 5% seawater was prepared and spiked with approximately 0.2 mCi of I-125. Cold iodine, as iodide (10 μg/l) and iodate (10 μg/l), was also added to the solution and stirred well giving a total iodine concentration of 20 μg/l. The mixture was then left overnight to equilibrate. The RBR was loaded with 7 g of AgGAC in two chambers and 7 g of GX-194 in the other two chambers. Assuming bulk densities of 0.64 g/ml for the GX-194 (obtained from the manufacturer's data sheet) and 0.54 g/ml for the AgGAC (measured in the laboratory), the volumes of media in the RBR were 21.9 ml and 25.9 ml for the GX-194 and AgGAC, respectively.

Prior to being placed in the simulant, the RBR was placed in a beaker of deionized water and pulsed several times to ensure no fines or media was being released. The parameters for the experiment were as follows: initial pH=7.4; spin speed=400 rpm; spin time=24 hours; initial I125 activity=595,700 Bq/1.

Samples were taken regularly, and the activity was measured on a Wizard so the rate of I-125 removal could be studied. The initial and final activities of the solution were also measured on a calibrated gamma detector to give absolute activity values as opposed to the raw counts per minute generated by the Wizard.

The final activity of the solution was 2,571.5 Bq/1, giving a total DF of 142 equivalent to the removal of 99.57% of the original activity. The rate of removal of I-125 was initially very rapid with 94.55% of the activity removed in the first hour. The rate of removal then decreased considerably, presumably due to the fact that once the total iodine concentration was reduced below μg/l levels, there was insufficient contact time between the media and the solution to allow an efficient interaction between the I-125 and the available adsorption sites.

The RBR from the initial experiment, now loaded with close to 0.2 mCi of activity, was placed in a second 20 L of 5% seawater solution spiked with I-125. This solution was prepared in the same manner as the first solution and also allowed to equilibrate overnight. The specific parameters for this second run were as follows: initial pH=7.00; spin speed=400 rpm; spin time=24 hours; initial I-125 activity=606,800 Bq/1.

The final activity of the second solution was 3670.4 Bq/1, giving a DF of 164 equivalent to the removal of 99.40% of the original activity. This result is very similar to the initial run and indicates that the capacity of the media was not significantly impacted by treating the first 20 L tank. Thus, the residual I-125 activity after 24 hours is not a media capacity issue and is most likely a mass transfer effect as mentioned previously. The data from both experiments is shown below in Table 5 and Table 6.

TABLE 5
Iodine removal - run 1

| | | | Iodine | Calculated |
|---|---|---|---|---|
| Time | Activity | | Removal | Iodine Con. |
| (min) | (cpm/ml) | DF* | (%) | (μg/l) |
| 0 | 20327.5 | 1.00 | 0.00 | 20.00 |
| 60 | 1107.36 | 18.36 | 94.55 | 1.09 |
| 120 | 464.38 | 43.77 | 97.72 | 0.46 |
| 180 | 319.67 | 63.59 | 98.43 | 0.31 |
| 270 | 264.76 | 76.78 | 98.70 | 0.26 |
| 330 | 245.5 | 82.80 | 98.79 | 0.24 |
| 390 | 206.81 | 98.29 | 98.98 | 0.20 |
| 450 | 198.62 | 102.34 | 99.02 | 0.20 |
| 1440 | 142.95 | 142.20 | 99.30 | 0.14 |

Decontamination Factor (DF) = initial concentration divided by the concentration at a given time.

TABLE 6
Iodine removal - run 2

| | | | Iodine | Calculated |
|---|---|---|---|---|
| Time | Activity | | Removal | Iodine Con. |
| (min) | (cpm/ml) | DF* | (%) | (μg/l) |
| 0 | 20123 | 1.00 | 0.00 | 20.00 |
| 60 | 1463.44 | 13.75 | 92.73 | 1.45 |
| 120 | 629.28 | 31.98 | 96.87 | 0.63 |
| 180 | 435.34 | 46.22 | 97.84 | 0.43 |
| 240 | 293.19 | 68.63 | 98.54 | 0.29 |
| 300 | 277.46 | 72.53 | 98.62 | 0.28 |
| 360 | 277.09 | 72.62 | 98.62 | 0.28 |
| 420 | 214.40 | 93.86 | 98.93 | 0.21 |
| 480 | 201.12 | 100.05 | 99.00 | 0.20 |
| 1440 | 121.05 | 166.24 | 99.40 | 0.12 |

Decontamination Factor (DF) = initial concentration divided by the concentration at a given time.

### Example 10-I-125 Isotopic Dilution

Based on the results of the I-125 kinetics experiment, it was decided to test the effect of adding additional cold iodine to the simulant after the bulk of the I-125 had been removed to see if this enhanced the rate of removal. A 5% seawater simulant was prepared and spiked with 0.2 mCi of 1-125, cold iodide and cold iodate as described in Example 9 and allowed to equilibrate overnight.

The RBR was loaded with 2 x 7g of AgGAC and 2 x 7g of GX-194 as described previously. The experiment was started and run for 8 hours with samples taken every hour for analysis on the Wizard 3. After 8 hours, the experiment was stopped, the RBR was withdrawn from the solution and equal amounts of cold iodide and iodate added to the solution to bring the total iodine concentration back up to approximately 20 μg/l. The solution was again allowed to equilibrate overnight. The next day, the RBR was replaced and run for an additional 8 hours with samples being taken every hour. The starting experimental parameters were as follows: initial pH =

7.82; spin speed =400 rpm; spin time =8 hours (x 2); initial I-125 activity =385,000 Bq/1.

The lower initial activity was due to decay of the I-125 between the time the initial experiments were performed and the isotopic dilution experiment. Since the amount of cold iodine remained constant, the reduced I-125 activity would not impact the experiment since the activity was solely utilized to follow the rate of iodine removal by the two media.

The results of the experiment were inconclusive. After 8 hours of reaction, the media had initially removed 98.09% of the I-125 which is considerably less than the previous experiment when 99.02% of the I-125 had been removed after 7.5 hours. After the cold iodine was added and the RBR restarted, there was a slight increase in the rate of I-125 removal compared to the end of the experiment on the first day but the expected large increase did not materialize. In theory, the results of this experiment should have been almost the same as those in Example 9 since the addition of cold iodine should have increased the rate at which the residual I-125 was removed. The reason for the difference in behavior is unknown.

### Trace I-125 Testing—Examples 11-12

The data obtained from Examples 9 and 10 indicated that the bulk of the I-125 uptake was complete after 8 hours of reaction time. This allowed trace I-125 experiments to be performed using activities similar to those found for 1-129 in nuclear tank wastes such as those found at

Fukushima. i.e. ˜25 Bq/1. Cold iodine (10 μg/l) was also added to these solutions to mimic the Fukushima waste which contains a mixture of radioactive 1-129 (approximately 4.2 μg/l), nonradioactive iodine from the environment and non-radioactive isotopes generated by fission. This low level of activity was not able to be measured accurately using the Wizard so only an initial and final activity were recorded using the germanium detector. To accurately analyze the final sample, a standard procedure for the determination of I-129 in environmental samples was followed which involved running 3 liters of the solution through an ion exchange resin and then directly counting the resin.

### Example 11-I-125 Removal Using Reduced Particle Sizes

In an effort to improve the mass transfer, samples of GX-194 and AgGAC were carefully ground, sieved and washed to give a narrow particle size range between 212 and 300 μm diameter. The ground media were carefully mixed together and used as a packed bed. A total mass of 40 g of a 50/50 by weight mixture of the media was carefully loaded into the RBR, completely filling the RBR. The spin speed was increased to 500 rpm for this experiment due to the greater resistance to flow expected from the reduced media particle size. Other parameters for the experiment were: initial pH=8.05; spin speed=500 rpm; spin time=8 hours; initial I-125 activity=28.6 Bq/1. The nuclear tank waste simulant had the properties described in the Trace I-125 Testing section.

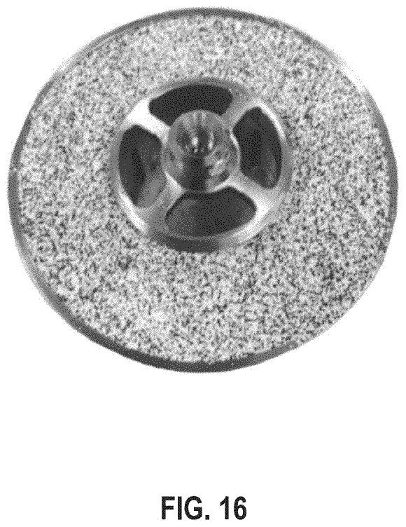

The RBR was initially pulsed a few times in a beaker containing deionized water to remove any fines or free media particles. However, despite this precaution, a small amount of media was released during the experiment. However, examination of the tank indicated that the amount of media lost was <<1% of the total media present and thus would not have unduly affected the experiment. Care was taken at the end of the experiment to preclude any fines when the sample was taken for analysis and as an added precaution, the three liters was filtered prior to analysis. A picture of the RBR at the end of the experiment with the top plate removed is shown below in FIG. 16. It is evident that the media is evenly packed with negligible losses incurred during the 8 hours of spinning. The final activity of the I-125 in the solution was determined to be 0.244 Bq/1, giving a total DF of 117 and a removal of 99.15% of the I-125.

### Example 12-I-125 Removal Using Double RBR

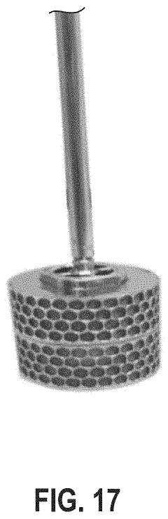

The purpose of this experiment was to maximize the amount of media in contact with the simulant. To achieve this, a second RBR was added to the set up as can be shown in FIG. 17. The regular sized GX-194 and AgGAC was used in this experiment since grinding and sieving the media was a laborious process and the previous experiment had shown limited benefits from the reduction in particle size.

The media in this experiment were kept as separate beds. One RBR was filled with 49.5 g of GX-194 while the other RBR was filled with 43.1 g of AgGAC as in the previous experiments. The simulant used consisted of 5% synthetic seawater spiked with 1-125, cold iodate, and iodide to give a total iodine concentration of approximately 10 μg/l. As with all iodine experiments, the solution was allowed to equilibrate overnight prior to use. Other experimental parameters were: initial pH=7.35; spin speed=400 rpm; spin time=8 hours; initial I-125 activity=30.8 Bq/1.

There was no evidence of media loss or fines generation during the course of the experiment. After 8 hours of spinning, the experiment was stopped, the RBR removed and a 3 liter sample taken for analysis. The final activity was determined to be 0.760 Bq/1. This corresponds to a DF of 41 and the removal of 97.5% of the I-125 activity. This performance is a little poorer than the single RBR with the smaller particle size mixed bed and indicates that decreasing the volume to mass ratio does not improve the performance.

To confirm that the residual 0.76 Bq/1 of I-125 was not readily removed, a further experiment was performed using the residual solution (approx. 16 L). A single RBR was filled with approximately 45 g of a 50/50 mixture of regular-sized AgGAC and GX-194 and placed in the residual simulant. This was then spun for 8 hours, removed from the solution and an additional 3 liter sample taken for analysis. A few media particles were released from the RBR but were insufficient to impact the performance. Analysis of the final sample indicated that the activity had been reduced further from 0.760 Bq/1 down to 0.414 Bq/1, an additional DF of 1.8 which corresponds to 45.5% removal. Overall, for a combination of the two runs, the total DF was 74 corresponding to the removal of 98.7% of the 1-125.

### Example 13-I-129 Removal

The isotope of concern in nuclear tank waste water such as at Fukushima is I-129, not the shorter-lived I-125 used for Examples 9-12. However, the chemistry of the two isotopes is exactly the same. To generate data using actual I-129, a single experiment was performed due to the limited availability of I-129. This used the standard 5% seawater to which had been added 2.5 μg/l of both non-radioactive iodide and iodate. When combined with the 1-129, this gave a total iodine content of approximately 10 μg/l which is the same as the I-125 experiments. The RBR included two compartments containing 7 g of AgGAC and two compartments containing 7 g of GX-194 which is less than the trace I-125 experiments. Other experimental parameters were: initial pH=7.56; spin speed=400 rpm; spin time=8 hours; initial 1-129 activity=26.9 Bq/1.

At the end of the experiment, the I-129 activity was reduced to 0.170 Bq/1, an overall DF of 158 which corresponds to 99.4% removal of the I-129. Based upon a total iodine concentration of 10 μg/l in the initial simulant, the final iodine concentration at the experiment was 0.06 μg/l or just 60 ng/l, assuming that the non-radioactive iodine behaves the same as the I-129. The performance was slightly better than the previous trace-level I-125 experiments, despite the lower amount of media used. This again suggests that mass transfer issues limit the removal of the I129 as opposed to media capacity.

### Sr-85 Testing—Examples 14-16

Examples 14-16 tested the performance of the RBR for removal of Sr-85. 0.5 mCi of Sr-

85 in 0.5 M HCl was obtained from PerkinElmer. This was diluted to a volume of 5 ml with 0.5 M HCl to generate a stock solution used for all the Sr-85 experiments. Synthetic seawater was not used for the Sr-85 experiments because the high levels of Ca and Mg would interfere with the Sr-85 removal. Significant concentrations of Ca and Mg are not present in applicable nuclear waste water because they would have been removed in an earlier treatment stage—e.g., a combination of carbonate precipitation stage and the Sr-Treat media. The simulant described in Table 7 was used for all of the Sr-85 work and is a reasonable representation of what would be found in nuclear tank waste such as the Fukushima tanks. Sodium was the other cation present in addition to the Ca, Mg, and Sr listed in the table.

TABLE 7
Nuclear waste water simulant for Sr-85 experiments

| Component | Concentration (mg/l) |
|---|---|
| Chloride | 800 |
| Sulfate | 50 |
| Bicarbonate | 50 |
| Calcium | 2 |
| Magnesium | 2 |
| Strontium | 0.05 |
| pH | 6.5-8.5 |

Because the Sr-85 stock solution contained acid, sodium hydroxide was used after the solution was spiked with Sr-85 to bring the pH back into the desired range. The media used for all experiments was UOP IONSIV R9515-G (20×50 mesh), which is a zeolite. The bulk density, determined in the laboratory, was approximately 0.78 g/ml. The zeolite was washed well to remove fines and then dried prior to use in the RBR.

### Example 14-Sr-85 Kinetics

20 liters of the simulant was prepared and spiked with roughly 0.1 mCi of Sr-85. This was adjusted to the desired pH range as described previously. The RBR was loaded with 10 g of washed zeolite (approximately 12.8 ml) per chamber and pulsed in a beaker of deionized water to remove fines. It was placed in the simulant and spun for 8 hours with samples taken every hour for analysis on the Wizard. Samples were also taken at the beginning and end of the experiment for analysis on the germanium detector. Other experimental parameters were: initial pH=8.06; spin speed=400 rpm; spin time=8 hours; initial Sr-85 activity=177,600 Bq/1.

The rate of uptake of the Sr-85 was very similar to the I-125 kinetic experiments and can be seen in Table 8. Approximately 95% of the Sr-85 was removed in the first hour and over 99% of the initial activity was removed at the end of the experiment. The final activity measured on the germanium counter was 1150.7 Bq/1 giving a total DF of 154. Assuming the non-radioactive strontium behaved the same as the Sr-85, this indicates the strontium concentration was reduced to 0.26 μg/l from an initial 50 μg/l.

TABLE 8
Sr-85 Removal

| | | | Strontium | Calculated |
|---|---|---|---|---|
| Time | Activity | | Removal | Strontium Con. |
| (min) | (cpm/ml) | DF* | (%) | (μg/l) |
| 0 | 3086.22 | 1.00 | 0.00 | 50.00 |
| 60 | 151.56 | 20.36 | 95.09 | 2.46 |
| 120 | 49.91 | 61.84 | 98.38 | 0.81 |
| 180 | 33.96 | 90.88 | 98.90 | 0.55 |
| 240 | 24.76 | 124.65 | 99.20 | 0.40 |
| 300 | 21.49 | 143.61 | 99.30 | 0.35 |
| 360 | 18.86 | 163.64 | 99.39 | 0.31 |
| 420 | 17.81 | 173.29 | 99.42 | 0.29 |
| 480 | 16.12 | 191.45 | 99.48 | 0.26 |

Decontamination Factor (DF) = initial concentration divided by the concentration at a given time.

### Example 15-Sr-85 Removal Using Double RBR

Another Sr-85 experiment was performed using two RBRs stacked on top of each other to investigate the effect of increasing the water flow through the media. 40 g of zeolite was used but instead of being distributed in 4 chambers of one RBR, the media was evenly distributed through the available 8 chambers of the two RBRs. Thus, the effective media contact time was halved compared to the first experiment but the volume to mass ratio has remained constant. Other experimental parameters were: initial pH=7.87; spin speed=400 rpm; spin time=8 hours; initial Sr-85 activity=170,940 Bq/l.

The initial rate of Sr-85 removal for the double RBR arrangement was similar to the initial run with over 94% of the activity removed in the first hour. The results are shown in Table 9. However, by the end of the experiment, the total amount of Sr-85 activity removed was slightly less than the result in Example 14. The final Sr-85 activity was reduced to 2075.8 Bq/l, a DF of 82.3 which is considerably less than the previous experiment which achieved a DF of 154. This indicates that halving the effective bed contact time but doubling the turnover rate of the tank is counterproductive. This is what would be expected if the Sr-85 removal was limited by mass transfer factors.

TABLE 9
Sr-85 Removal Using Double RBR

| | | | Strontium | Calculated |
|---|---|---|---|---|
| Time | Activity | | Removal | Strontium Con. |
| (min) | (cpm/ml) | DF* | (%) | (μg/l) |
| 0 | 2924.72 | 1.00 | 0.00 | 50.00 |
| 60 | 165.84 | 17.64 | 94.33 | 2.84 |
| 120 | 53.51 | 54.66 | 98.17 | 0.91 |
| 180 | 41.60 | 70.31 | 98.58 | 0.71 |
| 240 | 36.20 | 80.80 | 98.76 | 0.62 |
| 300 | 32.30 | 90.56 | 98.90 | 0.55 |
| 360 | 30.90 | 94.67 | 98.94 | 0.53 |
| 420 | 29.62 | 98.76 | 98.99 | 0.51 |
| 480 | 26.88 | 108.81 | 99.08 | 0.46 |

Decontamination Factor (DF) = initial concentration divided by the concentration at a given time.

### Example 16-Sr-85 Removal Using Reduced Spin Speed

Another experiment was run using the same set up as described in Example 14 except that after the first hour, the spin speed was reduced, effectively increasing the contact time with the media but decreasing the rate of turnover of the tank contents. 10 g of zeolite was used per chamber in a single RBR but after one hour of the experiment, the spin speed was reduced from 400 rpm to 200 rpm. Other experimental parameters were: initial pH=7.82; spin speed=400 rpm then 200 rpm after 1 hour; spin time=8 hours; initial Sr-85 activity=126,540 Bq/l.

The rate of Sr-85 removal was very similar to the rate in Example 14. The results are shown in Table 10. The total amount of Sr-85 activity removed was slightly less but greater than the double RBR run in Example 15. The final Sr-85 activity was reduced to 954.6 Bq/l, a DF of 133 which is only marginally less than the initial Sr-85 experiment which achieved a DF of 154. Given the proximity of the two results, it is difficult to say whether there was any effect achieved by reducing the spin speed after the first hour. The increased contact time was not effective at markedly increasing the removal of the trace amounts of Sr-85 that remained in solution after the bulk was removed in the first hour of the reaction.

TABLE 10
Sr-85 Removal Using Reduced Spin Speed

| | | | Strontium | Calculated |
|---|---|---|---|---|
| Time | Activity | | Removal | Strontium Con. |
| (min) | (cpm/ml) | DF* | (%) | (μg/l) |
| 0 | 2219.88 | 1.00 | 0.00 | 50.00 |
| 60 | 199.52 | 11.13 | 91.01 | 4.49 |
| 120 | 82.28 | 26.98 | 96.29 | 1.85 |
| 180 | 45.32 | 48.98 | 97.96 | 1.02 |
| 240 | 28.145 | 78.87 | 98.73 | 0.63 |
| 300 | 22.295 | 99.57 | 99.00 | 0.50 |
| 360 | 18.97 | 117.02 | 99.15 | 0.43 |
| 420 | 16.19 | 137.11 | 99.27 | 0.36 |
| 480 | 14.635 | 151.68 | 99.34 | 0.33 |

Decontamination Factor (DF) = initial concentration divided by the concentration at a given time.

### Example 17-Cs-137 Removal

In this example, Cs-137 removal was tested using a stock solution of Cs-137 (in 1M HCl). A 5% seawater solution was used as the simulant and was pH adjusted after the addition of the Cs-137 using sodium hydroxide. Only a low activity source of Cs-137 was available which meant that analysis on the Wizard would be subject to a high degree of uncertainty due to the low counts. It was therefore assumed, based upon the I-125 and Sr-85 experiments, that an 8-hour reaction time would suffice. No information on whether the Cs-137 used was carrier-free was available, thus the total amount of cesium (radioactive and non-radioactive) added to the seawater simulant was unknown. No cold cesium was added.

The RBR was packed with washed Cs-Treat so that all compartments were completely full. This took a total of 37.8 g of media. As usual, the RBR was pulsed a few times in deionized water to remove any fines prior to being placed in the 20 liter tank containing the 5% seawater simulant spiked with Cs-137. Other experimental parameters were: initial pH=6.65; spin speed =400 rpm; spin time=8 hours; initial Cs-137 activity=11,222 Bq/l.

Analysis of the final solution on the germanium detector gave a final Cs-137 activity of 38.99 Bq/l. This is equivalent to a DF of 288 which corresponds to the removal of 99.65% of the Cs-137 initially present in the solution. This is the highest DF obtained during the experiments and is probably because the Cs-Treat is known to have an exceptionally high affinity for Cs-137 under the conditions tested. The affinities of the other media tested are considerably lower which may be reflected in their poorer performance relative to Cs-Treat.

### Discussion of Results

The experimental work described in the Examples above clearly demonstrated the potential of utilizing a rotating bed apparatus technology in nuclear applications. The following conclusions can be made following the completion of the tests:

First, a selection of media used in nuclear effluent treatment applications have all be shown to be stable in the RBR and do not degrade and generate fines. The initial observation of CsTreat degrading during use turned out to be due to the nature of the solution as opposed to being due to the pressures generated in the RBR. Additional testing in a higher salinity solution demonstrated that the Cs-Treat was indeed stable. The stability of Cs-Treat is significant since this particular product is probably the most friable media currently in use.

Second, the RBR has excellent mixing characteristics and testing within a 20 liter tank demonstrated the liquid was homogeneous.

Third, both radioactive and non-radioactive testing demonstrated that the initial removal of contaminants from solution was very rapid and typically 95% or more was adsorbed within the first hour of operation under the experimental conditions tested. This is significantly faster than an equivalent volume of solution could be treated in a conventional fixed bed ion exchange system.

Fourth, the approach is simple, rugged and at the laboratory scale, is resistant to fouling by high concentrations of suspended solids. However, suspended solids may have more of an impact at a full scale when the effective media bed depth is greater.

Fifth, additional tests should to be performed at full scale to determine the optimum spin speed. The results of the spin speed experiments in the laboratory have been variable and not allowed firm conclusions to be drawn. Increasing the spin speed increases the turnover rate of the liquid being treated but reduces the contact time between the liquid and the media on each pass.

Sixth, experiments performed with species of interest initially present at the μg/l scale have clearly shown that once the concentration is reduced by an order of magnitude, the rate of removal slows drastically. DFs obtained have consistently been a few hundred when DFs of at least a thousand would be produced by an equivalent fixed bed system using the same media. In the fixed bed system, contact times would typically have been around 5 minutes giving plenty of opportunity for sub-microgram per liter species to interact with media adsorption sites. The relatively lower performance of the RBR system at these ultra-low levels suggests that it may be a mass transfer issue between the media and liquid phase. For non-nuclear applications where treatment goals are not as extreme, these mass transfer issues do not apply since contaminants only need to be removed down to mg/l or μg/l levels rather than the ng/l levels desired in most nuclear applications.

Seventh, loading and unloading the RBR at the laboratory scale is awkward and could result in undesired dose to the extremities during radioactive testing. It would be desirable to change the design for a large-scale unit that minimizes opportunities for media spillage and simplifies loading and unloading operations.

### Conclusions

The laboratory work demonstrated the viability of using a rotating bed apparatus for nuclear applications. Media stability, mixing effectiveness and the suitability of the overall rotating bed design were confirmed. However, the work has only been performed at a small scale and larger scale studies should be performed to further develop and confirm the approach. At the laboratory scale, limitations on the ability of the RBR to remove ultra-trace levels of contaminants have been revealed which is believed to be a function of mass transfer between the liquid and solid phase. For most applications outside the nuclear industry, this limitation would not be a problem since contaminants are generally present at much higher concentrations and do not need to be removed down to as low levels as in the nuclear industry. It is believed that this limitation does not apply when the system is used at a larger scale due to the increase in the effective contact time between the media and the liquid phase because of the increased effective bed depth. However, testing should to be performed to confirm this hypothesis.

The media commonly used in the nuclear industry for liquid waste treatment appeared to be stable in the RBR. Laboratory testing of the liquids after contact with the RBR for extended periods of time did not indicate the generation of significant amounts of fines and examination of the solid media also showed negligible evidence of degradation.

Laboratory experiments showed that the RBR is resistant to fouling by suspended solids (SS) and that the presence of high SS (exemplified by montmorillonite clay) only slightly reduced the rate of uptake of a dye. However, it is important to note that suspended solids may have more of an impact at the large scale where the effective media bed depth will be considerably greater.

There appears to be a trade-off between spin speed and efficiency of the system. At too high a flow rate (spin speed), the media is not effective at removing a contaminant because the contact time between the media and the liquid phase is just too short. A higher spin speed will give an increased turnover of a tank but beyond a certain limit it may prove to not be advantageous to increase the spin speed further. This effect is likely to be amplified in the laboratory scale due to the very short bed depths (<1 cm) and correspondingly short contact times.

Media was tested for the removal of radioisotopes of strontium, cesium and iodine. In all cases, the RBR was initially very effective and removed ˜95% of the radioactivity in one hour. However, after that, the rate of removal decreased dramatically with only another 4-4.5% of the initial activity removed even after 24 hours of additional reaction time. The reason for this is presumably due to mass transfer issues because the active component was reduced from tens of ppb (μg/l) down to hundreds of ppt (ng/l) levels meaning there just isn't sufficient time for a meaningful interaction between the media and solution. This should be much less of an issue at a large scale because of the increased bed depth and longer media contact times.

Using Sr-85, it was shown that using a single RBR was more efficient than using the same quantity of media split between two RBRs on top of each other. This was presumably due to the reduced bed depth. Assuming the flow rate was doubled using the additional RBR, the hydraulic loading rate (ml/cm2) through the media should have remained the same but the contact time was reduced by 50%. This data reinforces the comments about limiting mass transfer made in the previous paragraph indicating contact time is an important parameter.

In conclusion, the lab-based tests were encouraging and indicated that the RBR is likely a viable alternative to more expensive fixed bed ion exchange systems. However, testing at a larger scale using several kilograms of media with larger bed depths should be performed to generate additional data that can be used to guide full-scale development.

A series of experiments were designed to demonstrate the feasibility of operating a remotely deployed, large-scale RBR and to confirm whether the laboratory data obtained previously was scalable to an industrial application. The tests were designed to determine whether a trace contaminant could be successfully removed from a large volume of water and to obtain some information on both the rate of contaminant uptake and the effect of spin speed. They were designed to simulate but not to mimic conditions associated with the treatment of treated water stored at 1F.

A 57 L capacity RBR was manufactured for testing purposes. While this is smaller than the proposed 130 L RBR to be used at 1F, it allowed the demonstration of an RBR of industrial scale without requiring an excessively large tank.

Tests were performed using a 22 m³ tank. This tank was selected based on size and owner's capability to support deployment and testing of the RBR.

The function of a 96 L RBR (400 mm OD×100 mm ID×800 mm height) in the largest tank at the Fukushima site, 2700 m3 in volume, was tested by simulation.

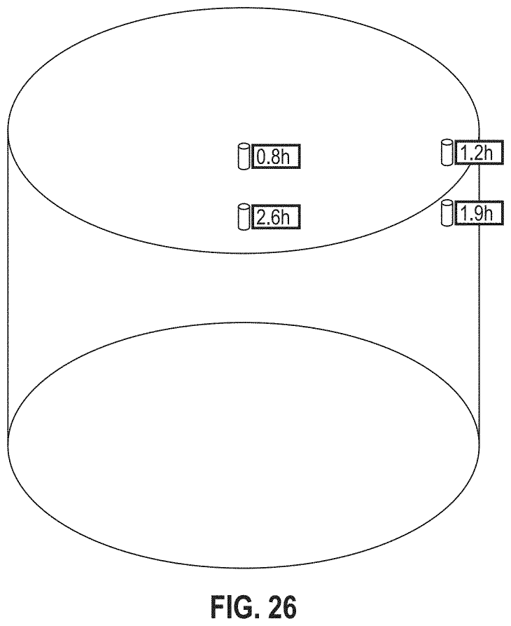

Due to restricted access into the tanks at the Fukushima site, it would not be possible to place the RBR at the center as in regular laboratory configurations. Thus, the flow rates through the RBR and the mixing time of the tank was monitored while changing the location of the RBR to evaluate the influence of placement on performance. With a viscous resistance coefficient (a) of 1.0E10 and at an RPM of 300, the flow rate was found to be roughly 25 m³/hr, independent of RBR placement. The mixing times of the tank, defined as the time required to reach within ±10% of the final value of concentration at any given point after starting with an inhomogeneous concentration are shown in FIG. 26.

In some embodiments, this illustrates that the mixing can be effective when the RBR is positioned above a centroid of the fluid volume, or positioned radially offset from a centroid of the volume of fluid.

In some embodiments, based on analysis and testing, the apparatuses, systems and methods described herein can configured/controlled by adjusting one or more of the following parameters:
Increasing rotation speed, to increase flow rate and hence reduce process time.
Adjusting the RBR aspect ratio—a larger inlet and thinner media bed can increase the flow rate, however may reduce the RBR media volume (and hence absorbance).
selection of media type from a physical (spherical or granular) perspective can, in some situations, also alter the porosity and hence flow rate and residence time in the media.

Testing has been carried out on a 57 L RBR, and further analysis on a 96 L RBR. Based on the analysis and testing carried out, from a RBR performance perspective, many sizes of the RBR may be adopted.

### Terminology and Interpretative Conventions

The term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The term “coupled” includes joining that is permanent in nature or releasable and/or removable in nature. Permanent joining refers to joining the components together in a manner that is not capable of being reversed or returned to the original condition. Releasable joining refers to joining the components together in a manner that is capable of being reversed or returned to the original condition.

Releasable joining can be further categorized based on the difficulty of releasing the components and/or whether the components are released as part of their ordinary operation and/or use. Readily or easily releasable joining refers to joining that can be readily, easily, and/or promptly released with little or no difficulty or effort. Difficult or hard to release joining refers to joining that is difficult, hard, or arduous to release and/or requires substantial effort to release. The joining can be released or intended to be released as part of the ordinary operation and/or use of the components or only in extraordinary situations and/or circumstances. In the latter case, the joining can be intended to remain joined for a long, indefinite period until the extraordinary circumstances arise.

It should be appreciated that the components can be joined together using any type of fastening method and/or fastener. The fastening method refers to the way the components are joined. A fastener is generally a separate component used in a mechanical fastening method to mechanically join the components together. A list of examples of fastening methods and/or fasteners are given below. The list is divided according to whether the fastening method and/or fastener is generally permanent, readily released, or difficult to release.

Examples of permanent fastening methods include welding, soldering, brazing, crimping, riveting, stapling, stitching, some types of nailing, some types of adhering, and some types of cementing. Examples of permanent fasteners include some types of nails, some types of dowel pins, most types of rivets, most types of staples, stitches, most types of structural ties, and toggle bolts.

Examples of readily releasable fastening methods include clamping, pinning, clipping, latching, clasping, buttoning, zipping, buckling, and tying. Examples of readily releasable fasteners include snap fasteners, retainer rings, circlips, split pin, linchpins, R-pins, clevis fasteners, cotter pins, latches, hook and loop fasteners (VELCRO), hook and eye fasteners, push pins, clips, clasps, clamps, zip ties, zippers, buttons, buckles, split pin fasteners, and/or conformat fasteners.

Examples of difficult to release fastening methods include bolting, screwing, most types of threaded fastening, and some types of nailing. Examples of difficult to release fasteners include bolts, screws, most types of threaded fasteners, some types of nails, some types of dowel pins, a few types of rivets, a few types of structural ties.

It should be appreciated that the fastening methods and fasteners are categorized above based on their most common configurations and/or applications. The fastening methods and fasteners can fall into other categories or multiple categories depending on their specific configurations and/or applications. For example, rope, string, wire, cable, chain, and the like can be permanent, readily releasable, or difficult to release depending on the application.

Any methods described in the claims or specification should not be interpreted to require the steps to be performed in a specific order unless stated otherwise. Also, the methods should be interpreted to provide support to perform the recited steps in any order unless stated otherwise.

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative embodiments where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The drawings shall be interpreted as illustrating one or more embodiments that are drawn to scale and/or one or more embodiments that are not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any and all ranges or subranges that can be formed by such values.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

### INCORPORATION BY REFERENCE

The entire contents of each of the documents listed below are incorporated by reference into this document. If the same term is used in both this document and one or more of the incorporated documents, then it should be interpreted to have the broadest meaning imparted by any one or combination of these sources unless the term has been explicitly defined to have a different meaning in this document. If there is an inconsistency between any of the following documents and this document, then this document shall govern. The incorporated subject matter should not be used to limit or narrow the scope of the explicitly recited or depicted subject matter.
German Pat. No. DE-2017351A1 (App. No. DE-19702017351), titled “Chemical Reaction on Insoluble Vehicle Using Centrifuging,” filed on 10 Apr. 1970, issued on 10 Oct. 1974.
Japan Pat. No. JP-S55157331A (App. No. JP-6861879A), titled “Ion Exchange Apparatus,” filed on 29 May 1979, issued on 8 Dec. 1980.
Canada Pat. No. CA-1143293 (App. No. CA-353226), titled “Apparatus and Process for Treating Liquid Material While Subjected to a Centrifugal Force,” filed on 2 Jun. 1980, issued on 22 Mar. 1983.
U.S. Pat. No. 4,683,062 (App. No. 06/803,815), titled “Method of Circulation of a Liquid Phase Through a Solid Phase Particularly for Biocatalytical Reactions and a Device for Realization Thereof,” filed on 2 Dec. 1985, issued on 28 Jul. 1987.
Japan Pat. No. JP-H0372998A (App. No. JP-20696389), titled “Liquid Treatment Device,” filed on 11 Aug. 1989, issued on 28 Mar. 1991.
U.S. Pat. No. 5,139,953 (App. No. 07/569,422), titled “Rotary Column Reactor,” filed on 20 Aug. 1990, issued on 18 Aug. 1992.
U.S. Pat. No. 5,200,074 (App. No. 07/771,990), titled “Ion-exchange Apparatus Having Rotatable Cartridges,” filed on 8 Oct. 1991, issued on 6 Apr. 1993.
U.S. Pat. No. 5,705,390 (App. No. 08/422626), titled “Bioreactor,” filed on 14 Apr. 1995, issued on 6 Jan. 1998.
U.S. Pat. No. 9,333,479 (App. No. 14/327153), titled “Device for Performing a Chemical Transformation in Fluidic Media,” filed on 9 Jul. 2014, issued on 10 May 2016.
U.S. Pat. Pub. No. 2016/0237391 (App. No. 15/026408), titled “A Process for Chemical and/or Biological Transformation,” filed on 31 Mar. 2016, published on 18 Aug. 2016.
U.S. Pat. Pub. No. 2016/0243462 (App. No. 15/027758), titled “A Reactor for Biological or Chemical Transformation,” filed on 7 Apr. 2016, published on 25 Aug. 2016.
U.S. Pat. Pub. No. 2016/0256843 (App. No. 15/029024), titled “An Auxiliary Reactor for Biological or Chemical Transformation,” filed on 13 Apr. 2016, published on 8 Sep. 2016.

1. An apparatus for processing industrial effluent, the apparatus comprising:
an annular body having an inner surface and an outer surface defining one or more chambers for retaining exchange media, the inner and outer surfaces defining a plurality of apertures, the inner surface defining a central volume in fluid communication with a central aperture at a first end of the annular body;
wherein, when rotated in a volume of fluid, the annular body facilitates fluid flow into the central volume via the central aperture, into the one or more chambers via the apertures defined by the inner surface, and out the apertures defined by the outer surface.

2. The apparatus of claim 1, wherein the exchange media is nuclear ion exchange media.

3. The apparatus of claim 1, comprising a mesh having apertures smaller than the apertures defined by the inner and outer surfaces for retaining the exchange media within the one or more chambers.

4. The apparatus of claim 1 comprising a drive shaft coupled to the annular body.

5. The apparatus of claim 4, wherein the drive shaft is coupled to a submersible motor.

6. The apparatus of claim 1 comprising a telescoping unit for raising or lowering the annular body into the volume of fluid.

7. The apparatus of claim 4 comprising an anti-rotation support for supporting the drive shaft within a mast.

8. The apparatus of claim 1 wherein a height of the annular body along its axis is greater than a depth of the annular body.

9. The apparatus of claim 1 wherein the annular body is configured to retain a defined quantity of exchange media, the defined quantity determined such that a depth of exchange media in the one or more chambers corresponds to a desired flow rate or residence time of the fluid flowing through the one or more chambers.

10. The apparatus of claim 1, wherein the annular body comprises one or more walls separating an internal volume of the annular body into a plurality of chambers.

11. The apparatus of claim 10, wherein at least two of the plurality of chambers retain different exchange media.

12. A system comprising: the apparatus of claim 1, and a mast mountable on a support such that the annular body can be extended into the volume of fluid through the mast.

13. The system of claim 12 wherein the mast is mountable to a vessel containing the volume of fluid.

14. The system of claim 13 comprising a vessel aperture adaptor plate configured to be securely mounted to an external portion of the vessel surrounding an opening in the vessel, wherein when the vessel aperture adaptor plate is securely mounted to the external portion of the vessel, the mast extends into the volume of fluid in the vessel.

15. A method for processing industrial effluent, the method comprising:
positioning, in a volume of fluid, a rotating bed apparatus comprising one or more chambers retaining exchange media; and
rotating the rotating bed apparatus to facilitate fluid flow through the one or more chambers of the rotating bed apparatus.

16. The method of claim 15 comprising: positioning the rotating bed apparatus into the volume of fluid via an interior of a mast, the mast mountable on a support and extending towards or into the volume of fluid.

17. The method of claim 15 comprising: rotating the rotating bed apparatus in the volume of fluid at a first speed during a first time period to facilitate mixing of the volume of fluid, and rotating the rotating bed apparatus in the volume of fluid at second speed during a second time period to provide a residence time which enables exchange media ion exchange or absorption.

18. The method of claim 16 comprising: supporting the rotating bed apparatus against the mast during rotation of the rotating bed apparatus.

19. The method of claim 16 comprising securing the mast at an aperture in a vessel containing the volume of fluid with an adapter device adjustably configurable for securing to the vessel based on a size of the aperture in the vessel.

20. The method of claim 15 comprising positioning the rotating bed apparatus in the fluid at a position above a centroid of the volume of fluid, or at a position radially offset from a centroid of the volume of fluid.
